(19) United States
(12) Patent Application Publication
(10) Pub. No.: US 2016/0299874 A1
(43) Pub. Date: Oct. 13, 2016

(54) SHARED MEMORY EIGENSOLVER

(71) Applicant: Silicon Graphics International Corp., Milpitas, CA (US)

(72) Inventor: Cheng Liao, Pleasanton, CA (US)

(21) Appl. No.: 15/132,085

(22) Filed: Apr. 18, 2016

Related U.S. Application Data
(63) Continuation-in-part of application No. 14/537,839, filed on Nov. 10, 2014.
(60) Provisional application No. 62/149,061, filed on Apr. 17, 2015.
(60) Provisional application No. 61/901,731, filed on Nov. 8, 2013.

(51) Int. Cl. G06F 17/16

(52) U.S. Cl. CPC G06F 17/16

(57) ABSTRACT

Disclosed herein is a shared memory system that use a combination of SBR and MRRR techniques to calculate eigenpairs for dense matrices having very large numbers of rows and columns. The disclosed system allows for the use of a highly scalable tridiagonal eigensolver. The disclosed system likewise allows for allocating a different number of threads to each of the different computational stages of the eigensolver.

### CROSS-REFERENCE TO RELATED APPLICATIONS

The present application claims the priority benefit of U.S. provisional application 62/149,061, filed on Apr. 17, 2015; the present application is also continuation in part of U.S. patent application Ser. No. 14/537,839, which claims the priority benefit of U.S. provisional application 61/901,731 filed on Nov. 8, 2013. The present application also incorporates by reference U.S. patent application Ser. No. 14/536,477, filed on Nov. 7, 2014. The disclosure of each of the foregoing applications is incorporated herein by reference.

### BACKGROUND OF THE INVENTION

1. Field of the Invention

The present invention generally relates to a non-uniform memory access (NUMA) computer system. More specifically, the present invention relates to computing eigenvalues and eigenvectors of a very large matrix in a NUMA computer system.

2. Description of the Related Art

Some data modeling applications use matrices that describe transformations of physical parameters. For example, a cosmological model of a galaxy might use a matrix to describe the motion of stars in space. A finite element model of a material may use a matrix to model stresses in a material at a number of different locations. These matrices transform initial property vectors of the model into final property vectors by standard matrix multiplication

For any transformation by matrix multiplication, there may be certain vectors for which the transformation merely acts to lengthen or shorten the vector. These vectors are called “eigenvectors” of the transformation. Eigenvectors provide “preferred directions”; vectors parallel to eigenvectors are not rotated by the transformation. The corresponding scaling factor of the lengthening or shortening for a given direction is called the “eigenvalue” for the eigenvector.

Different eigenvectors may have different corresponding eigenvalues, and eigenvectors with an eigenvalue of 1 are not lengthened or shortened by the transformation; for these vectors, the transformation preserves length. Eigenvectors and eigenvalues provide a useful mathematical tool to analyze matrix transformations. It is, therefore, desirable to be able to compute eigenvectors and eigenvalues (collectively, “eigenpairs”) for any given matrix.

Several techniques are known to calculate eigenpairs of a matrix. One family of “eigensolver” techniques first reduces the matrix to a tridiagonal form. A tridiagonal form is a form in which the main diagonal of the matrix and the diagonals just above and below may contain non-zero numbers; all other entries are zero. Such an eigensolver computes the eigenpairs of the tridiagonal matrix then converts the computed eigenvectors back to the original reference system.

In order to improve scalability, the ACM TOMS 807 algorithm, or successive band reduction (“SBR”), is often employed for the tridiagonal reduction phase. In SBR, the initial, densely-populated matrix is reduced to a multiple band intermediate form having many non-zero diagonals in a first stage. The matrix is later reduced from the multiple band form to the tridiagonal (three band) form in the second stage.

After calculating the eigenpairs in a third stage, the eigenvector back-transformation also requires two stages: from the tridiagonal to the multiple band reference system in stage four and to the original dense reference system in stage five. The multistage SBR approach allows highly scalable BLAS-3 computing kernels to be used, but the two stage eigenvector back-transformation introduces additional floating point operations that influence scalability.

LAPACK (Linear Algebra Package) is a standard software library for numerical linear algebra. LAPACK provides routines for solving systems of linear equations and linear least squares, eigenvalue problems, and singular value decomposition. LAPACK also includes routines to implement associated matrix factorizations. The ScaLAPACK (or Scalable LAPACK) library includes a subset of LAPACK routines redesigned for distributed memory MIMD parallel computers. ScaLAPACK allows for interprocessor communication and assumes matrices are laid out in a two-dimensional block cyclic decomposition.

LAPACK and ScaLAPACK both have underlying deficiencies. For example, neither LAPACK or ScaLAPACK employ SBR calculations. Nor is LAPACK designed for scalability. And the ScaLAPACK library communicates using the aforementioned message passing, which is slower than communication using shared memory for tridiagonal eigensolvers.

The Parallel Linear Algebra Software for Multicore Architectures (“PLASMA”) is a mathematical library for performing conversion of a dense symmetric array to and from tridiagonal form on shared memory systems with multi-core processors. An example of such systems are shown in FIG. 1-3 as described below. PLASMA includes a tiled storage of the data arrays and a DAG (directed acyclic graph) scheduling of the computational subtasks. PLASMA improves over older LAPACK and ScaLAPACK libraries in terms of memory usage pressure, process synchronization requirements, task granularity, and load balance. PLASMA results in increased performance and scalability for sufficiently large problems.

PLASMA nevertheless suffers from a number of shortcomings, especially with respect to solving very large problems. For example, PLASMA is limited to 32-bit architectures. Because matrix entries are addressed using 32-bit signed integers, the largest matrix on which PLASMA may operate has a dimension N limited to the square root of the largest 32-bit signed integer (N=sqrt(2³¹)=46340). This value of N is too low to operate on matrices that have hundreds of thousands or millions of rows and columns, as is required by some computations.

Because PLASMA is limited to smaller matrices, PLASMA does not use a tridiagonal eigenpair solver that effectively scales for larger matrices. While algorithms such as the multiple relatively robust representations (“MRRR”) algorithm exist to achieve such scaling, PLASMA is not designed to use them. PLASMA also operates on a fixed pool of threads. This is disadvantageous because different subtasks that occur in the five stages of the eigensolver may occur in parallel and have different computational complexities. A static thread allocation for all five stages is inefficient.

There is a need in the art for shared memory systems that use a combination of SBR and MRRR techniques to calculate eigenpairs for dense matrices having very large numbers of rows and columns. There is a further need for shared memory systems that are not merely “scaled up” versions of PLASMA that allow for increased scalability but that allow for the use of a highly scalable tridiagonal eigensolver. There is a still further need for a shared memory system that is capable of allocating a different number of threads to each of the different computational stages of the eigensolver.

There also is a need for systems and methods that improve the efficiency of solving linear equations using an eigensolver.

### SUMMARY OF THE CLAIMED INVENTION

The presently claimed invention includes a method, a non-transitory computer readable storage medium, and a system that increases the efficiency of an Eigensolver. A method consistent with the present invention populates data in a matrix, identifies a series of tile sets in the matrix, and identifies a series of domains in the matrix. A set of processors may then process data from the series of domains when converting that data from a densely populated form to a band form incrementally. As the tile sets are converted into the band form, resultant data may be stored for later use.

When the method is implemented as a non-transitory computer readable storage medium, it may also include steps relating to: populating data in a matrix, identifying a series of tile sets in the matrix, and identifying a series of domains in the matrix. A set of processors may then process data from the series of domains when converting that data from a densely populated form to a band form incrementally. As the tile sets are converted into the band form, resultant data may be stored for later use.

A system consistent with the presently claimed invention may include a plurality of processor sockets, and each of the processor sockets may include one or more CPUs and a memory. Each CPU in the system may then populate a matrix, identify a series of tile sets in the matrix, and identify a series of domains in the matrix. The CPUs may then process data from the series of domains when converting that data from a densely populated form to a band form incrementally. As the tile sets are converted into the band form, resultant data may be stored for later use. The system may also include communication interfaces over which each of the CPUs may access memory at each of the processor sockets.

### BRIEF DESCRIPTION OF THE DRAWINGS

FIG. 1 illustrates a High Performance Computing (HPC) system.

FIG. 2 illustrates a physical view of the HPC system of FIG. 1.

FIG. 3 illustrates a blade chassis of the HPC system of FIGS. 1 and 2.

FIG. 4 illustrates five processes executed by a scalable eigensolver in an HPC system.

FIG. 5 is an algorithm listing of the first step illustrated in FIG. 4.

FIG. 6 is an algorithm listing of the second step shown in FIG. 4.

FIG. 7 is a directed acyclic graph (DAG) illustrating scheduling dependencies between tasks performing the first and second steps shown in FIG. 4 for a 3×3 matrix.

FIG. 8 illustrates the impact of variation of a tile size parameter with respect to compute time.

FIG. 9 illustrates the impact of variation of a block size parameter with respect to compute time.

FIG. 10 illustrates the impact of variation of a rank multiplier parameter on the first process of FIG. 4.

FIG. 11 is a parametric study of compute threads in the first process of FIG. 4.

FIG. 12 illustrates an exemplary set of tiles in a dense matrix.

FIG. 13 illustrates an exemplary method that performs Householder computations on a plurality of Householder domains in a tile set in parallel.

FIG. 14 depicts an algorithm implemented in program code that transforms a dense matrix into a band matrix according to the method of FIG. 13.

FIG. 15 illustrates the impact of dividing a tile set into a plurality of Householder domains.

FIG. 16A illustrates experimental data when four Householder domains were used in a dense to band reduction.

FIG. 16B illustrates the same dense to band reduction performed using only one Householder domain.

FIG. 17 illustrates a lower portion of a band matrix as it is being reduced to a tridiagonal matrix.

FIG. 18 illustrates regions in the matrix as the “bulge chasing” process proceeds.

FIG. 19 illustrates a band matrix, where banded data in the band matrix includes an upper and a lower part.

FIG. 20 illustrates program code that implements the improved bulge chasing method consistent with the present disclosure.

FIG. 21 illustrates data from that compares the performance of a bulge chasing method as implemented originally in PLASMA versus the performance when bulge chasing is performed with the program code of FIG. 20.

FIG. 22 illustrates how the allocation of threads to CPU or socket core mapping affects workload distribution on a plurality of processor sockets when reducing a band matrix into a tridiagonal matrix.

### DETAILED DESCRIPTION

Embodiments of the present disclosure may use symmetric multiprocessing (SMP), a message passing interface (MPI), and open multiprocessing (OpenMP). Where SMP is a hardware and software architecture where two or more identical processors connect to a single, shared main memory, have full access to all I/O devices, and are controlled by a single operating system instance that treats all processors equally, reserving none for special purposes. MPI is a standardized and portable message-passing system designed by a group of researchers from academia and industry to function on a wide variety of parallel computers. OpenMP is an application program interface (API) that supports multi-platform shared memory multiprocessing programming in C, C++, and Fortran on most platforms, processor architectures and operating systems, including Solaris, AIX, HP-UX, Linux, OS X, and Windows. It consists of a set of compiler directives, library routines, and environment variables that influence run-time behaviour. An MPI program could run on a computer cluster that consists of a set of loosely coupled nodes where each of the nodes may run their own instances of operating system software.

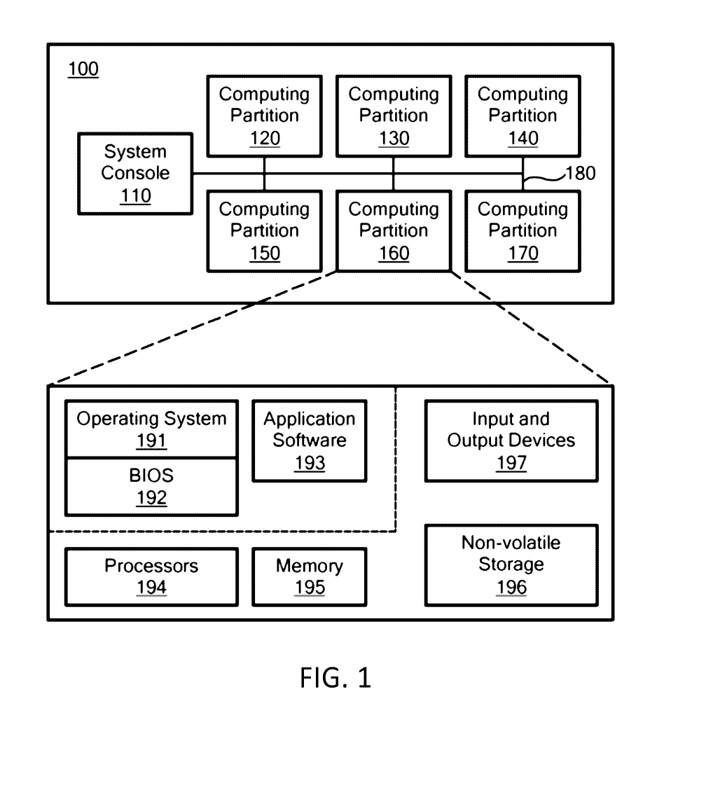

FIG. 1 illustrates a High Performance Computing (HPC) system 100. A high-performance computing system or HPC system is generally understood to be a computing system having multiple modular computing resources. These resources are communicatively coupled to one another using hardware interconnects. Through such a communicative coupling, processors may directly access remote data using a common memory address space.

The HPC system 100 of FIG. 1 includes a number of logical computing partitions 120-170. Partitions 120-170 provide computational resources. System console 110 manages the aforementioned partitions 120-170. A “computing partition” or “partition” in an HPC system (like that illustrated in FIG. 1) is generally understood to be an administrative allocation of computational resources that runs a single operating system instance and has a common memory address space. Partitions 120-170 may communicate with system console 110 using a logical communication network 180. Computing partitions are also referred to as sockets or processing sockets, where each computing partition may include a plurality of processing cores.

A system user such as a scientist or engineer who desires to perform a calculation may request computational resources from a system operator. The system operator uses the system console 110 to allocate and manage those resources, which may occur automatically. The HPC system 100 may have any number of administratively assigned computing partitions. Some HPC systems may only have one partition that encompasses all of the available computing resources.

Each computing partition, such as partition 160, may be logically viewed as if it were a single computing device akin to a desktop computer. Partition 160 may execute software including an instance of an operating system (“OS”) 191 that uses a basic input/output system (“BIOS”) 192. Partition 160 may further execute application software 193 for one or more system users. As is also shown in FIG. 1, a computing partition has various allocations of hardware including one or more processors 194, volatile memory 195, non-volatile storage 196, and input and output (“I/O”) devices 197. Examples of I/O devices 197 include network cards, video display devices, and keyboards.

In HPC systems like that shown in FIG. 1, each computing partition typically has more processing power and memory than a commercial desktop computer. The OS software may include a Windows®-based operating system from Microsoft Corporation or an open source solution, such as a Linux operating system. Although the BIOS may be provided as firmware by a hardware manufacturer such as Intel Corporation, the BIOS of an HPC system is typically customized according to the needs of the system designer to support specific high-performance computing needs.

System console 110 may act as an interface between the computing capabilities of the computing partitions 120-170 and the system operator or other computing systems. System console 110 of FIG. 1 issues commands to the HPC system hardware and software on behalf of the system operator and that permit the likes of booting hardware, dividing system computing resources into computing partitions, initializing partitions, monitoring the health of each partition and any hardware or software errors generated therein. Further operations under the command and control of system console 110 may include distributing operating systems and application software to various partitions, causing the operating systems and software to execute, backing up the state of the partition or software therein, shutting down application software, and shutting down a computing partition or the entirety of HPC system 100.

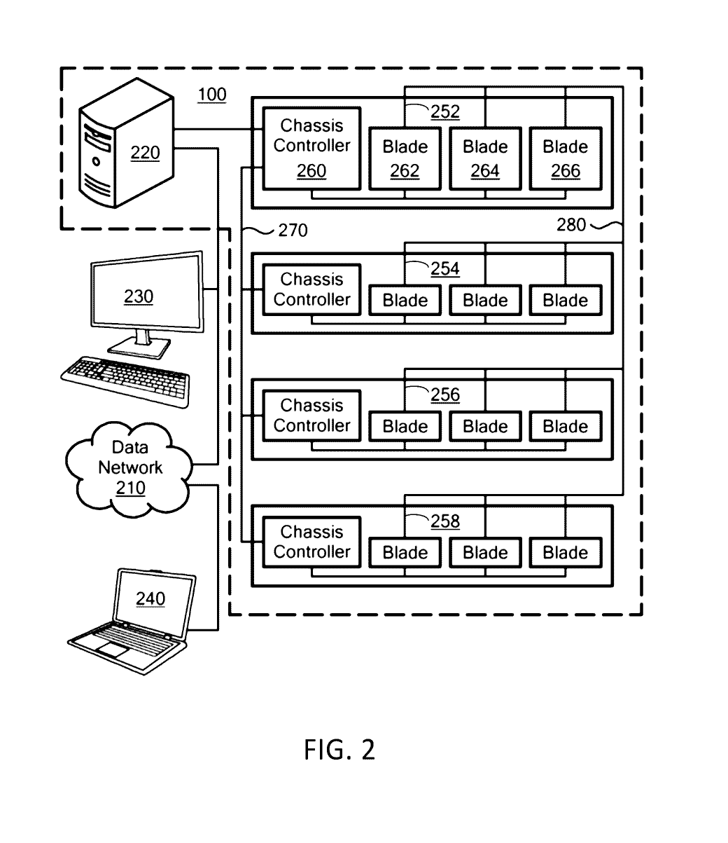

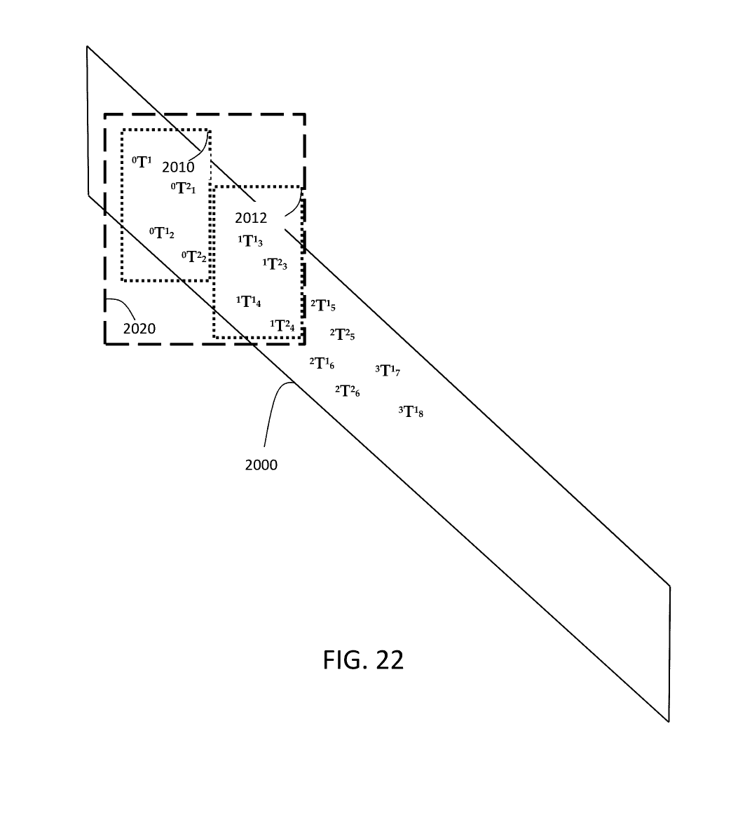

FIG. 2 illustrates a physical view of the HPC system 100 of FIG. 1. The hardware of HPC system 100 of FIG. 1 is surrounded by the dashed line in FIG. 22. The HPC system 100 is connected to an enterprise data network 210 to facilitate user access.

The HPC system 100 illustrated in FIG. 2 includes a system management node (“SMN”) 220 that performs the functions of the system console 110. The management node 220 may be implemented as a desktop computer, a server computer, or other computing device that may be provided by either the enterprise or the HPC system designer. Management node 220 of FIG. 2 includes the software necessary to control the HPC system 100 (i.e., system console software).

The HPC system 100 of FIG. 2 is accessible using the data network 210. Network 210 may include any data network known in the art, such as an enterprise local area network (“LAN”), a virtual private network (“VPN”), the Internet, or a combination of these networks. Any of these networks may permit a number of users to remotely and/or simultaneously access the HPC system resources. For example, the management node 220 may be accessed by an enterprise computer 230 by way of remote login using tools known in the art such as Windows® Remote Desktop Services or the Unix secure shell.

If the enterprise is so inclined, access to the HPC system 100 may be provided to a remote computer 240. The remote computer 240 may access the HPC system by way of a login to the management node 220 as described above. Access may also occur using a gateway or proxy system as is known to persons od ordinary skill in the art.

The hardware computing resources of the HPC system 100 (e.g., the processors, memory, non-volatile storage, and I/O devices shown in FIG. 1) are collectively provided by one or more “blade chassis” such as blade chassis 252-258 as illustrated in FIG. 2. A blade chassis is an electronic chassis that houses, powers, and provides high-speed data communications between multiple stackable, modular electronic circuit boards called “blades.” Each blade includes enough computing hardware to act as a standalone computing server. The modular design of a blade chassis permits the blades to be connected to power and data lines with a minimum of cabling and vertical space. Chassis 252-258 of FIG. 2 are managed and allocated into computing partitions.

Each blade chassis (e.g., blade chassis 252) has a chassis management controller 260 for managing system functions in the blade chassis 252. Chassis management controller 260 may in some instances be referred to as a “chassis controller” or “CMC.” Chassis controller 260 likewise controls the system functions of the individual blades (e.g., 262-266) in a given chassis.

Each blade (e.g., blade 262) contributes its hardware computing resources to the collective total resources of the HPC system 100. The system management node 220 manages the hardware computing resources of the entire HPC system 100 using the chassis controllers, such as chassis controller 260. Each chassis controller, in turn, manages the resources for the blades in its particular blade chassis. The chassis controller 260 is physically and electrically coupled to the blades 262-266 inside the blade chassis 252 by local management bus 268. The hardware in the other blade chassis 254-258 is similarly configured.

Chassis controllers communicate with each other using a management connection 270. The management connection 270 may be a high-speed LAN running an Ethernet communication protocol or other data bus. By contrast, the blades communicate with each other using computing connection 280. The computing connection 280 of FIG. 2 may be a high-bandwidth, low-latency system interconnect like NumaLink, which is a system interconnect developed by Silicon Graphics International Corp. for use in its distributed shared memory computer systems.

Chassis controller 260 provides system hardware management functions to the rest of the HPC system 100. Chassis controller 260 may receive a system boot command from the SMN 220 and respond by issuing boot commands to each of the blades 262-266 using local management bus 268. Chassis controller 260 may similarly receive hardware error data from one or more of the blades 262-266 and store this information for later analysis with error data stored by the other chassis controllers.

SMN 220 or an enterprise computer 230 may, in some embodiments of FIG. 2, be provided access to a single, master chassis controller 260. A master chassis controller 260 may process system management commands to control the HPC system 100 and forward these commands to other chassis controllers. In some instances, SMN 220 may only be directly coupled to the management connection 270. SMN 220 may individually issue commands to each chassis controller. Other variations of design are within the scope of the presently disclosed invention but readily configurable by those persons having ordinary skill in the art.

The blade chassis 252, the computing hardware of its blades 262-266, and the local management bus 268 may be configured as known in the art. The chassis controller 260, however, may be implemented using hardware, firmware, or software provided by the HPC system designer. Each blade provides the HPC system 100 with some quantity of processors, volatile memory, non-volatile storage, and I/O devices that are known in the art of standalone computer servers. Each blade also has hardware, firmware, and/or software to allow these computing resources to be grouped together and collectively treated as computing partitions.

While FIG. 2 illustrates an HPC system 100 having four chassis and three blades in each chassis, it should be appreciated that the scope of the invention is not limited to this particular illustrative embodiment. An HPC system may have dozens of chassis and hundreds of blades. HPC systems are often desired because they provide very large quantities of tightly-coupled computing resources. In this regard, any number of variations of the configuration of an HPC system like that shown in FIG. 2 are possible and that would otherwise remain within the scope of the present invention.

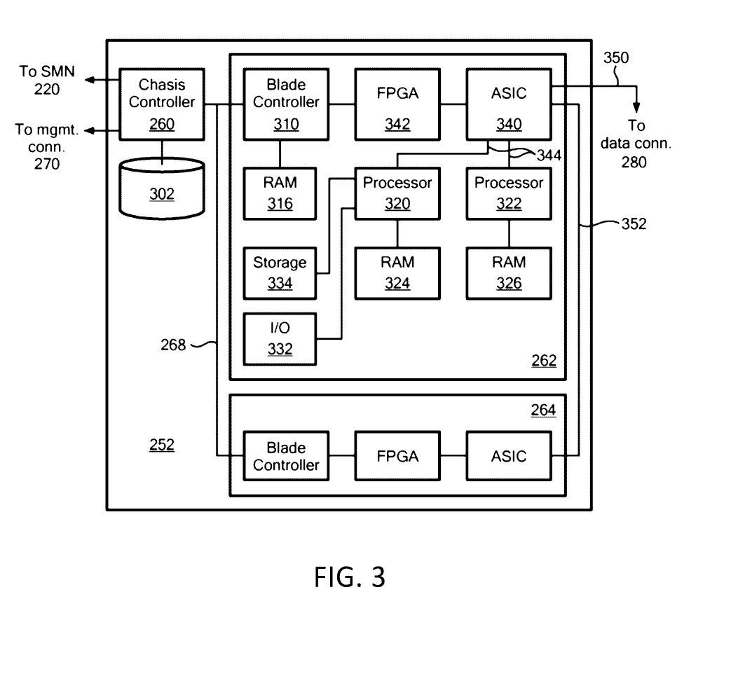

FIG. 3 illustrates a blade chassis (252) of the HPC system 100 of FIGS. 1 and 2. Parts and components not necessary to understanding the immediate description that follows have been omitted from FIG. 3 in order to simplify said discussion. The chassis controller 260 is illustrated with connections to system management node 220 and management connection 270. Chassis controller 260 may be provided with a chassis data store 302 for storing chassis management data. The chassis data store 302 may be volatile random access memory (“RAM”) whereby data would be accessible by the SMN 220 so long as power is applied to the blade chassis 252 even if one or more of the computing partitions has failed or an individual blade has malfunctioned. Chassis data store 302 may also be non-volatile storage such as a hard disk drive (“HDD”) or a solid state drive (“SSD”). Data in the chassis data store 302 in such an embodiment would remain accessible after the HPC system has been powered down and rebooted.

Blade 262 includes a blade management controller 310 (also called a “blade controller” or “BMC”) that executes system management functions at a blade level. The operations of BMC 310 at the blade level are analogous to the functions performed by a chassis controller at the chassis level. The blade controller 310 may be implemented as custom hardware designed by the HPC system designer to permit communication with the chassis controller 260. Blade controller 310 may have its own RAM 316 to carry out management functions. The chassis controller 260 in FIG. 3 communicates with the blade controller 310 of each blade using the local management bus 268.

The blade 262 illustrated in FIG. 3 also includes one or more processors 320 and 322 that are connected to RAM 324 and 326, respectively. Blade 262 may be alternately configured so that multiple processors may access a common set of RAM on a single bus. Processors 320 and 322 may include any number of central processing units (“CPUs”) or cores. Processors 320 and 322 in blade 262 of FIG. 3 are connected to other components such as a data bus that allows for communication with I/O devices 332 and a data bus that communicates with non-volatile storage 334. Other buses commonly found in standalone computing systems may similarly be implemented.

Processors 320 and 322 may be Intel® Core™ processors manufactured by Intel Corporation. The I/O bus may be a PCI or PCI Express (“PCIe”) bus. The storage bus may be a SATA, SCSI, or Fibre Channel bus. Other bus standards, processor types, and processor manufacturers may be used in accordance with the illustrative embodiment shown in FIG. 3.

Each blade in FIG. 3 (e.g., the blades 262 and 264) include an application-specific integrated circuit 340, which may be referred to as an “ASIC,” “hub chip,” or “hub ASIC” that controls its functionality or portions thereof. To logically connect processors 320 and 322, RAM 324 and 326, and other devices such as I/O device 332 and storage 334 to form a managed, multi-processor, coherently-shared distributed-memory HPC system, the processors 320 and 322 are electrically connected to the hub ASIC 340. The hub ASIC 340 of FIG. 3 provides an interface between the HPC system management functions generated by the SMN 220, chassis controller 260, and blade controller 310, and the computing resources of the blade 262.

As illustrated in FIG. 3, hub ASIC 340 connects with the blade controller 310 by way of a field-programmable gate array (“FPGA”) 342 or similar programmable device for passing signals between integrated circuits. Signals are generated on output pins of the blade controller 310 in response to commands issued by the chassis controller 260. These signals are translated by the FPGA 342 into commands for certain input pins of the hub ASIC 340 and vice versa. For example, a “power on” signal received by the blade controller 310 from the chassis controller 260 requires, among other things, providing a “power on” voltage to a certain pin on the hub ASIC 340, which is facilitated by the FPGA 342.

The field-programmable nature of the FPGA 342 permits the interface between the blade controller 310 and ASIC 340 to be reprogrammable after manufacturing. Thus, the blade controller 310 and ASIC 340 may be designed to have certain generic functions while the FPGA 342 may be used advantageously to program the use of those functions in an application-specific way. The communications interface between the blade controller 310 and ASIC 340 may also be updated if a hardware design error is discovered in either module thereby permitting a quick system repair without requiring new hardware to be fabricated.

Hub ASIC 340 may also be connected to processors 320 and 322 by way of a high-speed processor interconnect 344. Processors 320 and 322 may be connected using the Intel® QuickPath Interconnect (“QPI”). Hub ASIC 340 may include a module for communicating with processors 320 and 322 using QPI. Other processor interconnect configurations may be implemented in the context of FIG. 3.

The hub chip 340 in each blade also provides connections to other blades for high-bandwidth, low-latency data communications. Hub chip 340 may include a link 350 to computing connection 280 that connects different blade chassis. Link 350 may be implemented using networking cables. The hub ASIC 340 of FIG. 3 may also include connections to other blades in the same blade chassis 252. The hub ASIC 340 of blade 262 in FIG. 3 connects to the hub ASIC 340 of blade 264 by way of a chassis computing connection 352. The chassis computing connection 352 may be implemented as a data bus on a backplane of the blade chassis 252 rather than using networking cables thereby allowing for the high speed data communication between blades that is typically required for high-performance computing tasks. Data communication on both the inter-chassis computing connection 280 and the intra-chassis computing connection 352 may be implemented using the NumaLink protocol or a similar protocol.

System management commands may propagate from the SMN 220 through the management connection 270 to the blade chassis and their chassis controllers. Management commands may subsequently be communicated to blades and blade controllers. SNM 200 originated commands may finally be conveyed to the hub ASICS that implement those commands using system computing hardware.

In exemplary embodiments of the present invention, the HPC system 100 may be powered when a system operator issues a “power on” command from the SMN 220. The SMN 220 propagates this command to each of the blade chassis 252-258 by way of their respective chassis controllers such as chassis controller 260 in blade chassis 252. Each chassis controller, in turn, issues a “power on” command to each of the respective blades in its blade chassis by way of their respective blade controllers such as blade controller 310 of blade 262. Blade controller 310 issues a “power on” command to its corresponding hub chip 340 using the FPGA 342, which provides a signal on one of the pins of the hub chip 340 there by allowing for initialization. Other commands may similarly propagate.

Once the HPC system is powered on, its computing resources may be divided into computing partitions. The quantity of computing resources that are allocated to each computing partition is an administrative decision. For example, an enterprise may have a number of projects to complete and each project is projected to require a certain amount of computing resources. Different projects may require different proportions of processing power, memory, and I/O device usage. Different blades may have different quantities of installed resources. The HPC system administrator or an executable administration application may take these considerations into account when partitioning the computing resources of the HPC system 100. Partitioning computing resources may be accomplished by programming the RAM 316 of each blade. For example, the SMN 220 may issue appropriate blade programming commands after reading a system configuration file.

The collective hardware computing resources of the HPC system 100 may be divided into computing partitions according to any administrative need and subsequently created configuration file. A single computing partition may include the computing resources of some or all of the blades of one blade chassis 252, all of the blades of multiple blade chassis 252 and 254, some of the blades of one blade chassis 252, all of the blades of blade chassis 254, or even the entirety of the computing resources of the HPC system 100. Hardware computing resources may be statically partitioned, in which case a reboot of the entire HPC system 100 will be required to reallocate hardware. Hardware computing resources may also be dynamically partitioned while the HPC system 100 is powered on. Unallocated resources may be assigned to a partition without necessarily interrupting the operation of other partitions.

Once the HPC system 100 has been appropriately partitioned, each partition may be considered to act as a standalone computing system. Thus, two or more partitions may be combined to form a logical computing group inside the HPC system 100. Such grouping may be necessary if a particular computational task is allocated more processors or memory than a single operating system can control. For example, if a single operating system can only control 64 processors, but a particular computational task requires the combined power of 256 processors, then four partitions may be allocated to the task in such a group. This grouping may be accomplished by installing the same software on each computing partition and providing the partitions with a VPN.

Once at least one partition has been created, the partition may be booted and its computing resources initialized. Each computing partition, such as partition 160, may be viewed logically as having a single OS 191 and a single BIOS 192. A single logical computing partition 160 may span several blades, however, or even several blade chassis. A processor 320 or 322 inside a blade may be referred to as a “computing node” or simply a “node” to emphasize its allocation to a particular partition. It should be understood that a physical blade may comprise more than one computing node if it has multiple processors and memory.

Booting a partition requires a number of modifications to be made to a blade chassis. In particular, the BIOS in each blade is modified to determine other hardware resources in the same computing partition and not just those in the same blade or blade chassis. After a boot command has been issued by the SMN 220, the hub ASIC 340 provides an appropriate signal to the processor 320 to begin the boot process using BIOS instructions. The BIOS instructions, in turn, obtain partition information from the hub ASIC 340 such as an identification (node) number in the partition, a node interconnection topology, a list of devices that are present in other nodes in the partition, and a master clock signal used by all nodes in the partition.

With this information, the processor 320 may then take whatever steps are required to initialize the blade 262. These steps include non-HPC-specific steps such as initializing I/O devices 332 and non-volatile storage 334. HPC-specific steps may also be initiazlied such as synchronizing a local hardware clock to a master clock signal, initializing HPC-specialized hardware in a given node, managing a memory directory that includes information about which other nodes in the partition have accessed its RAM, and preparing a partition-wide physical memory map.

Each physical BIOS will at this point in the configuration process have its own view of the partition. The computing resources in each node are then prepared for the OS to load. The BIOS reads the OS image and executes the same. The BIOS presents the OS with a view of the partition hardware as if it were all present in a single computing device, including that hardware scattered amongst multiple blade chassis and blades. The OS instance effectively spreads itself across some, or preferably all, of the blade chassis and blades that are assigned to a given partition. Different operating systems may be installed on the various partitions. If an OS image is not present immediately after partition, the OS image may be installed before the partition boots.

Once the OS executes, its partition may be operated as a single logical computing device. Software for carrying out desired computations may be installed to the various partitions by the HPC system operator or an application executing under the control thereof. Users may then log into the SMN 220 and obtain access to their respective partitions. Access may be controlled using volume mounting and directory permissions based on login credentials.

The system operator may monitor the health of each partition and take remedial steps when a hardware or software error is detected. The current state of long-running application programs may be saved either periodically or on the command of the system operator or application user to non-volatile storage to guard against losing work in the event of a system or application crash. The system operator or a system user may issue a command to shut down application software. When administratively required, the system operator or an administrative application may entirely shut down a computing partition, reallocate or deallocate computing resources in a partition, or power down the entire HPC system 100.

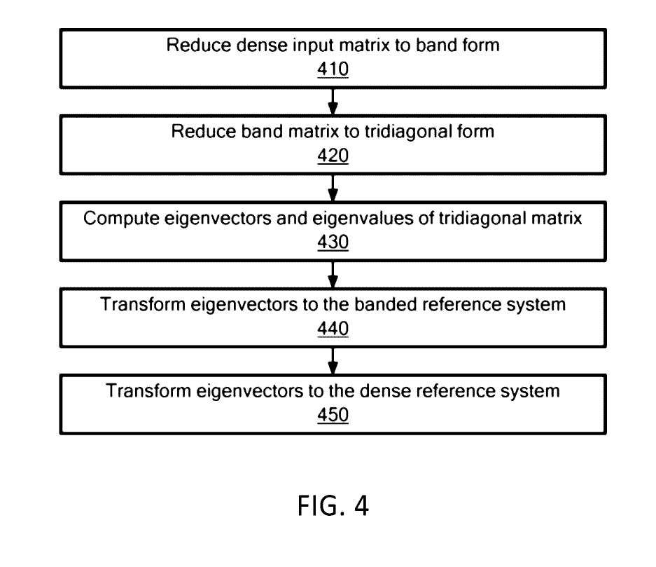

FIG. 4 illustrates five processes executed by a scalable eigensolver in an HPC system 100 like that of FIG. 1. The methodology of FIG. 4 begins with a square, symmetric, input matrix for which a user desires to calculate eigenvectors and eigenvalues (collectively, eigenpairs). The matrix is typically dense, rather than sparse. “Dense” matrices are those matrices whose entries are primarily non-zero. Dense matrices typically require more computational resources so these matrices are converted into band matrices and tridiagonal matrices as described herein.

In step 410 of FIG. 4, the dense input matrix is reduced to a band matrix. A “band matrix” is a sparse matrix whose non-zero entries are confined to diagonal bands that include the main diagonal and a number of diagonals on either side of (that is, above or below) the main diagonal. The total number of such bands is called the matrix “bandwidth.” A purely diagonal matrix has a bandwidth of one; all non-zero entries are confined to a single band along the main diagonal. A tridiagonal matrix has a bandwidth of three. Step 410 as illustrated in FIG. 4, however, does not convert the input matrix to a tridiagonal matrix but rather converts the input matrix to a matrix having a bandwidth larger than three.

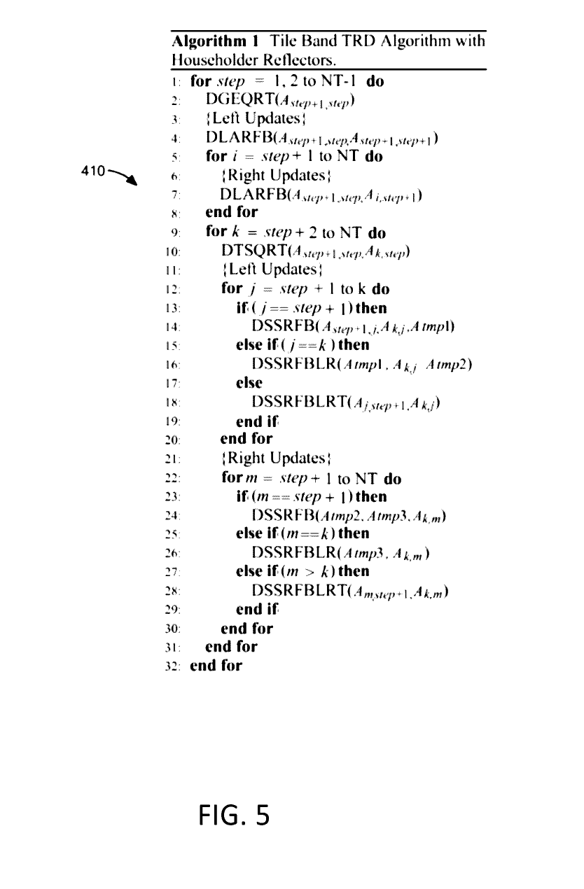

In this regard, reference is made to FIG. 5. FIG. 5 is an algorithm listing of the first step illustrated in FIG. 4 (410). The algorithm depicted in FIG. 5 is exemplary. Other algorithms may be utilized to achieve the same result as otherwise described with respect to step 410 of FIG. 4. Whatever algorithm might be chosen, it should be noted that step 410 cooperates with step 420 to reduce the dense input matrix to a tridiagonal matrix.

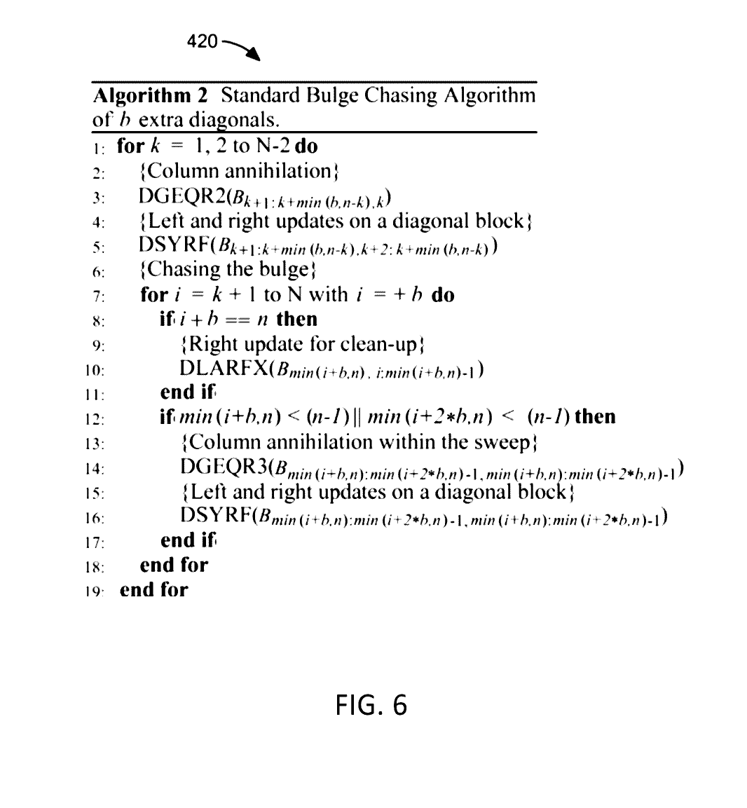

In a second step (420) as illustrated in FIG. 4, the band matrix is further reduced to a tridiagonal form. Such tridiagonal matrices lend themselves to various computational shortcuts that are not present in matrices having larger bandwidths. Such reduction may be achieved utilizing an algorithm like that disclosed in FIG. 6. FIG. 6 is an algorithm listing of the second process (420) shown in FIG. 4. The algorithm depicted in FIG. 6 is exemplary. Other algorithms may be utilized to achieve the same result as otherwise described with respect to step 420 of FIG. 6.

Steps 410 and 420, as noted above, cooperate to reduce the dense input matrix to a tridiagonal matrix. The algorithms depicted in FIGS. 5 and 6 for implementing steps 410 and 420, respectively, are described in LAPACK Working Note (“LAWN”) 244 and entitled “Two-Stage Tridiagonal Reduction for Dense Symmetric Matrices using Tile Algorithms on Multicore Architectures,” the disclosure of which is incorporated herein by reference.

Step 410 of FIG. 4 operates by performing successive band reduction (“SBR”). Step 420 of FIG. 4 operates by performing Householder reflections. A key difference between SBR and Householder reflections is that the SBR computation is mostly matrix-matrix multiplications while the Householder computation involves primarily matrix-vector multiplications. Matrix-matrix multiplications permit greater economies of scale when operating on an HPC system like that of FIG. 1 because they permit tighter data reuse.

To be specific in a matrix-matrix multiplication, each entry of the first matrix is multiplied by a collection of entries of the second matrix; each entry is used multiple times. This multiple use permits so-called block or tile matrix multiplication, which is efficient in an HPC system like that of FIG. 1. In a matrix-vector multiplication, however, each entry of the matrix is multiplied by only a single entry of the vector. Therefore, the matrix-matrix operations of SBR in process 410 are better suited to data localization in an HPC system 100 than the matrix-vector operations of Householder reflections in process 420.

There is a tradeoff between the amount of data localization and the overall computational efficiency that must be addressed. If the SBR block (or “tile”) size is large, then the bandwidth of the sparse matrix resulting from step 410 will be high thereby causing step 420 to take a great and sometimes inefficient length of time. If the SBR tile size is smaller, then the data logistic requirements become expensive and an excessive amount of time may be spent distributing tiles and aggregating results of tile multiplications.

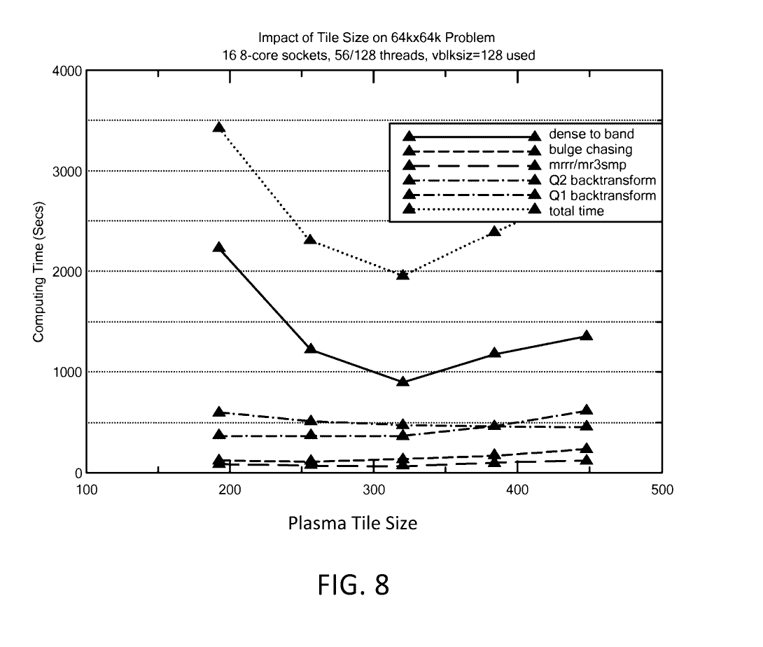

In one embodiment of the present invention it has been determined that an optimum tile size for certain Intel® processors is between about 128 and 512 entries on each side of a square tile and preferably close to 300 entries per side. Other embodiments may be optimized using different tile sizes. FIG. 8 illustrates the impact of variation of a tile size parameter with respect to compute time. In order to avoid shared memory network hotspots, all the memory pages are evenly distributed in a round-robin fashion over the computing nodes for achieving the best performance.

Step 430 requires computing eigenvectors and eigenvalues of the tridiagonal matrix obtained from step 420. While many methods are available, including power iteration, inverse iteration, the bisection method, and divide-and-conquer, one embodiment uses the multiple relatively robust representations (MRRR) method, which is implemented in MR3SMP and scales on large numbers of processors.

Step 440 and 450 may be implemented using an application of the Householder reflectors from steps 410 and 420 to the eigenvectors of the tridiagonal matrix to obtain the eigenvectors of the original matrix. Step 440 transforms the computed eigenvectors of the tridiagonal matrix into eigenvectors of the band matrix using data obtained during step 420. Step 450 transforms the eigenvectors of the band matrix into eigenvectors of the input matrix using data obtained during step 410.

The floating point intensive work in the eigensolver occurs in steps 410, 440, and 450. These steps have floating operation counts of (5/3)*N³, 2.5*N³ and 2.5*N³, respectively, where N is the dimension of the matrix. Step 420 has 6*(tile size)*N² floating point operation count, so it can be left out of the eigensolver scalability considerations if the chosen tile size is sufficiently small. Also, the floating point operation count of step 430 is O(N²) instead of O(N³) such that the MRRR implementation details may be omitted from the considerations for the overall eigensolver scalability. While the computation scales as O(N³), linear improvements can be made to the runtime by adjusting various parameters.

The scalability and performance of the three floating point intensive processes at steps 410, 440, and 450 are largely influenced by the number of computing threads (NTHDS), the PLASMA tile size (NB), and an internal VBLKSIZ blocking factor that impacts only step 420. Each of these stages would perform most optimally for certain but not necessarily identical NTHDS, NB, and VBLKSIZ. Moreover, if a particular value of NTHDS is less than the available total number of computing cores, the computing threads can either be concentrated on a few nodes or scattered over many computing nodes to further alleviate network hotspots. The scattering of the computing threads is controlled by a RANK_MULTIPLIER environmental variable.

NB and VBLKSIZ should be kept constant throughout the different stages of FIG. 4. Tile size NB may be set to a large enough number to permit efficient computation but not so large as to start to lose performance. Such a balance should be maintained in an effort to optimize the eigensolver performance on large numbers of multi-core processors. FIG. 8 illustrates an analysis of the impact of tile size on computing time in an order 64k matrix. In the embodiment that produced the data reflected in FIG. 8, the optimal tile size was approximately 320 or at least within the range 256 to 384.

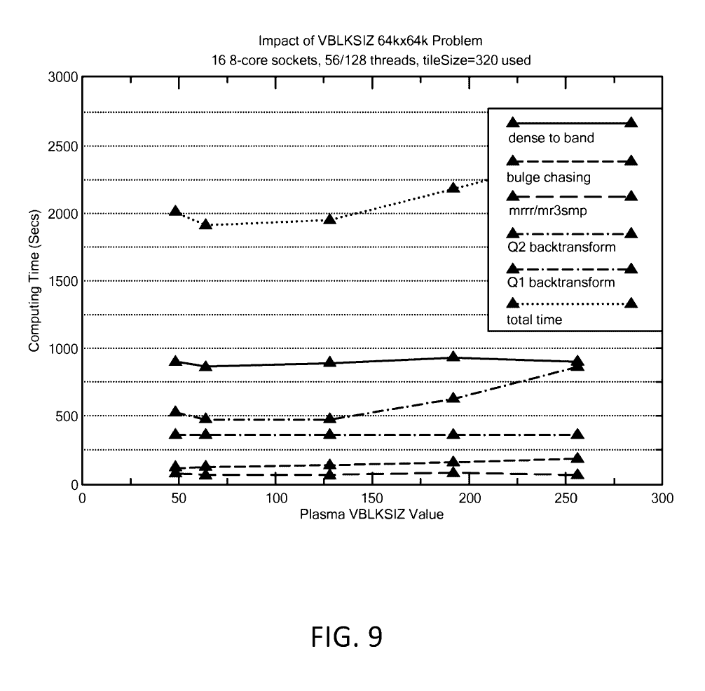

If the runtime for step 440 is very large compared to that of steps 410 or 450, VBLKSIZ is increased until the runtime of step 440 no longer dominates that of the other steps. FIG. 9 illustrates the impact of variation of a block size parameter with respect to compute time. FIG. 9 is a graph showing the impact of variation of the VBLKSIZ parameter in the computing time of an exemplary embodiment. The value of this parameter in FIG. 9 affects run time primarily in the Q2 back-transform stage (i.e., step 440). In the embodiment tested to produce the data reflected in FIG. 9, the optimal VBLKSIZ is approximately 64 or at least within the range 48 to 128.

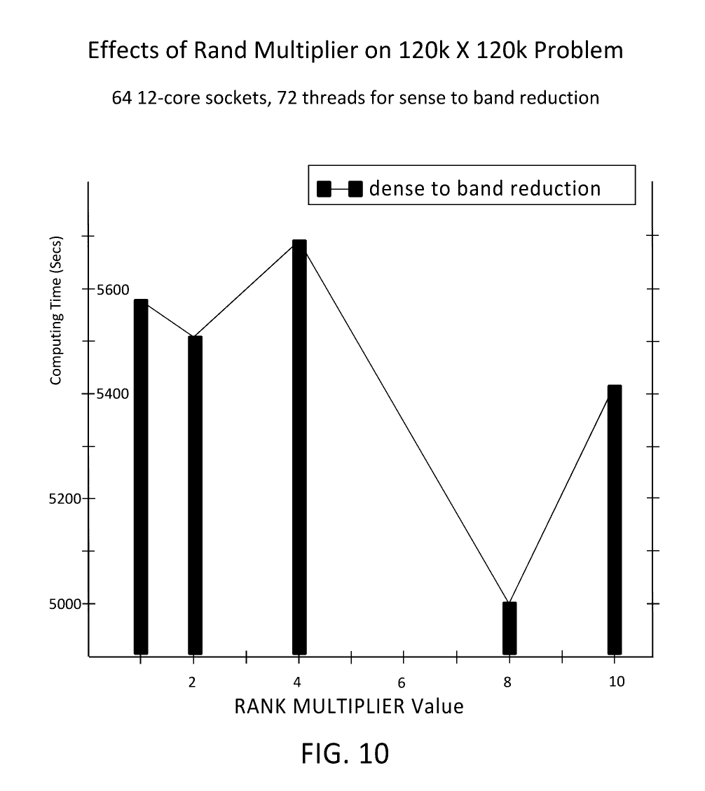

The RANK_MULTIPLIER parameter can be adjusted to improve the performance of step 410. FIG. 10 illustrates the impact of variation of a rank multiplier parameter on the first process of FIG. 4. FIG. 10 is an example showing such an optimization for this step in an order 120k matrix. In the embodiment tested to produce the data reflected in FIG. 10, the optimal RANK_MULTIPLIER is 8.

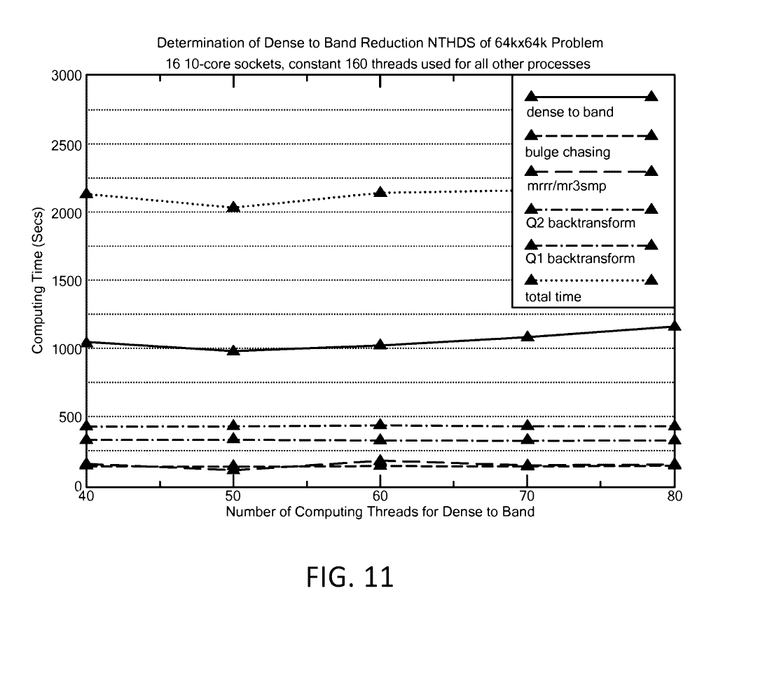

In a PLASMA implementation, the PLASMA infrastructure is shut down and reinitiated with a different value of NTHDS between each of steps 410-450 as shown in FIG. 4. The number of threads is separately and respectively determined for each step as a function of the relative runtimes of the individual steps. In this way, each of steps 410-450 can use the optimal number of threads. For example, FIG. 11 is a parametric study of compute threads in the first process of FIG. 4. FIG. 11 shows a parametric study for determining the best number of threads (NTHDS) for the dense-to-band reduction (step 410) of an order 64k matrix. In the embodiment tested to produce the data of FIG. 11, the optimal number of threads is approximately 50, or at least in the range 40 to 60.

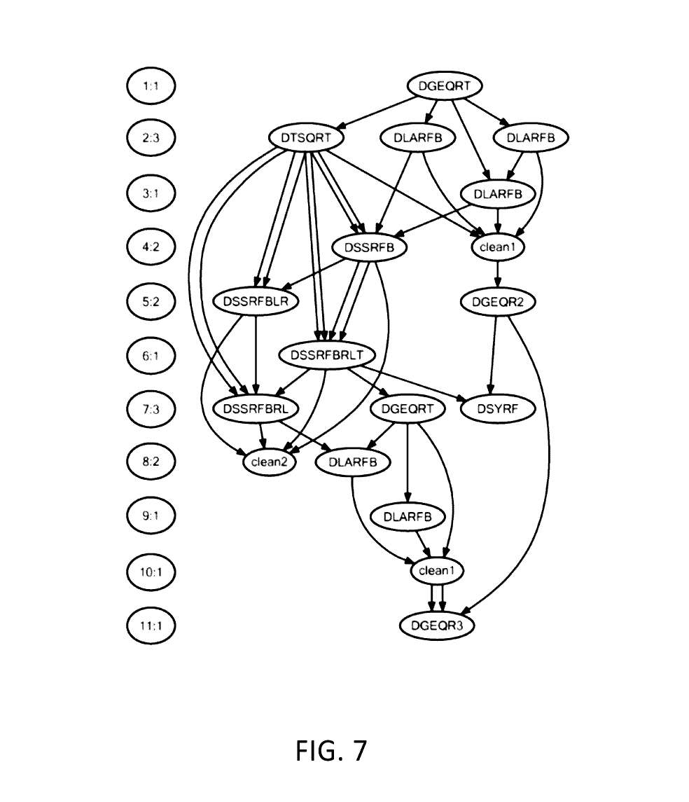

The algorithms used in FIGS. 4-5 may operate using multiple cores in an HPC system 100. A PLASMA implementation itself relies on runtime scheduling of parallel subtasks (i.e., functions such as matrix multiplications). However, some subtasks depend on others, and the relationships between the subtasks can be complex. The relationships may be expressed through a task graph, typically shown as a directed acyclic graph (DAG), which can be explored at runtime. An example of the DAG for steps 410 and 420 is shown in FIG. 7. FIG. 7 is a directed acyclic graph (DAG) illustrating scheduling dependencies between tasks performing the first and second steps shown in FIG. 4 for a 3×3 matrix.

The ovals on the left denote a step in the algorithmic sequence and the number of subtasks that can be executed in parallel in that step. Each subtask may execute on a number of cores. While all processes may be dynamically scheduled using a DAG, steps 420, 440 and 450 may be statically scheduled for improved performance.

The present invention may be embodied in many different forms, including but not limited to, computer program logic for use with a processor such as a microprocessor, microcontroller, digital signal processor, or general purpose computer; programmable logic for use with a programmable logic device such as a Field Programmable Gate Array (FPGA) or other PLD; discrete components; integrated circuitry such as an Application Specific Integrated Circuit (ASIC); or various combinations of the foregoing.

Computer program logic implementing all or part of the functionality previously described may be embodied in various forms, including but not limited to source code, an executable, or various intermediate states that might be generated by the likes of an assembler, compiler, linker, or locator. Source code may include a series of computer program instructions implemented in any of various programming languages for use with various operating systems or operating environments. The source code may define and use various data structures and communication messages. The source code may be in a computer executable form (e.g., via an interpreter), or the source code may be converted (e.g., via a translator, assembler, or compiler) into a computer executable form. The computer program may be embodied in any tangible form as may occur in the context of a tangible storage medium such as a semiconductor memory device, a magnetic memory device, an optical memory device, a PC card, or other memory component.

Hardware logic (including programmable logic for use with a programmable logic device) implementing all or part of the functionality previously described may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

The present disclosure includes methods for improving the performance of an Eigensolver solving Eigenpairs of dense symmetric matrices on a plurality of CPUs. Systems implementing methods consistent with the present disclosure may include a plurality of nodes with global shared memory capable of executing with a high degree of parallelism. To improve the performance of an Eigensolver, one or more of the steps of FIG. 4 transforming a dense matrix to a band matrix 410, reducing the band matrix into a matrix in tridiagonal form 420, computing Eigenvectors and Eigenvalues of the tridiagonal matrix 430, back-transforming the computed Eigenvectors in a tridiagonal matrix into a band matrix 440, and back-transforming the Eigenvectors in the band matrix to Eigenvectors in a dense matrix 450.

There is no need to back-transform Eigenvalues calculated in step 430 into a band matrix or into a dense matrix because even if these back-transformations were performed, the resulting Eigenvalues would be identical to those calculated in step 430 of FIG. 4. This is not true for the Eigenvectors calculated in step 430. Before the Eigenvectors yielded in step 430 can be interpreted using a reference system consistent with the reference system of the original dense matrix. As such, the Eigenvalues calculated in step 430 may simply be stored in memory, where the Eigenvectors calculated in step 430 must be back-transformed into a band matrix and then into a dense matrix before they can be evaluated.

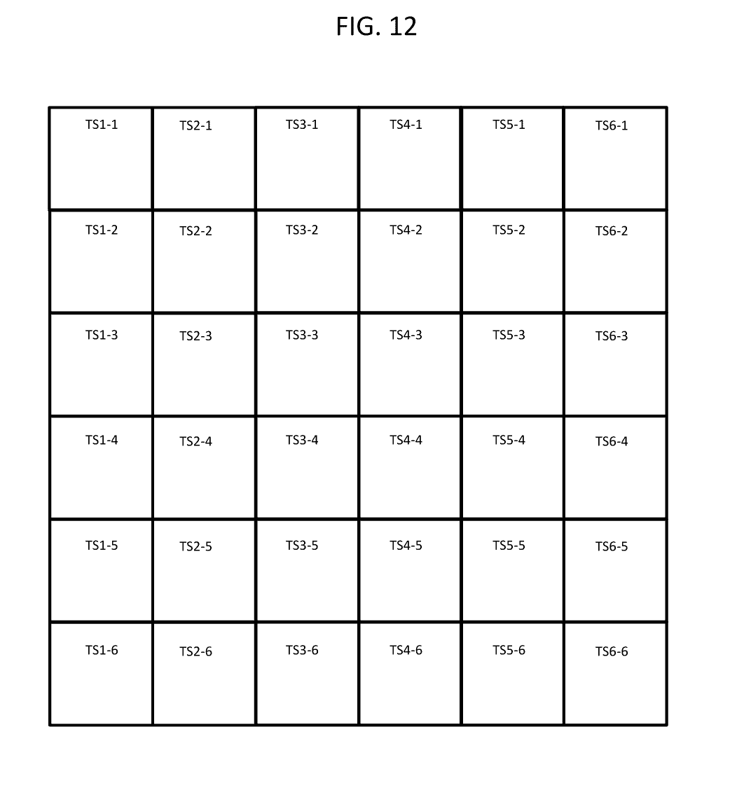

FIG. 12 illustrates an exemplary set of tiles in a dense matrix. Factors affecting the efficiency of an Eigensolver include the organization and size of the dense matrix. By organizing the dense matrix into a series of tiles, each tile includes a series of rows and columns in the dense matrix, and where the dense matrix includes a series of sets of tiles arranged in a plurality of columns, the dense matrix may be reduced to band form by “pseudo-incrementally” transforming each set of tiles one column at a time starting from a first set of columns. FIG. 12, a plurality of tiles organized in six different columns, illustrates an exemplary dense matrix that has been partitioned into a series of columns of tile sets. Each in FIG. 12 tile is uniquely identified, for example, tile set 1 includes tiles TS1-1, TS1-2, TS1-3, TS1-4, TS1-5, and TS1-6. Each tile in each of the different tile sets is numbered similarly, where tile set 2 includes: TS2-1, TS2-2, TS2-3, TS2-4, TS2-5, and TS2-6; and tile set 6 includes: TS6-1, TS6-2, TS6-3, TS6-4, TS6-5, and TS6-6.

Commonly transformations of a dese matrix to a band matrix includes performing matrix calculations beginning with a tile of a first tile set since the first tile TS1-1 is typically already in a tridiagonal form, the first tile processed by the band to tridiagonal process may be TS1-2 of the first tire set. After tile TS1-2 of tile set 1 is transformed, subsequent tiles in the tile set incrementally, where tiles TS1-3 through TS1-6 would be transformed sequentially. After one or more of tiles in the tile set 1 are transformed, transformation of tiles in the tile set 2 may be initiated (started), as such the transformation of tile TS2-3 may be begun before tile set 1 is completely transformed into a band matrix. As such, tiles may be transformed in a manner that is not completely incremental. For example, the transformation may be performed in a “pseudo-incremental”manner where a tile in a subsequent tile set is transformed in parallel with transformations of an immediately preceding tile set after a number of the transformations in the preceding tile set have already been transformed.

One unique aspect of the present disclosure includes dividing a tile set of a dense matrix of an Eigensolver problem into a series of domains, performing transformations on each of those domains in parallel, and populating a band matrix with the results of the transformations of each of the domains. Since this process performs Householder QR computations, each domain may be referred to as a Householder domain processed according to a series of Householder computations in parallel. As such each of these domains may be referred to as a Householder domain that spans a portion of a tile set in a dense matrix used to perform calculations that transform the dense matrix into a band matrix.

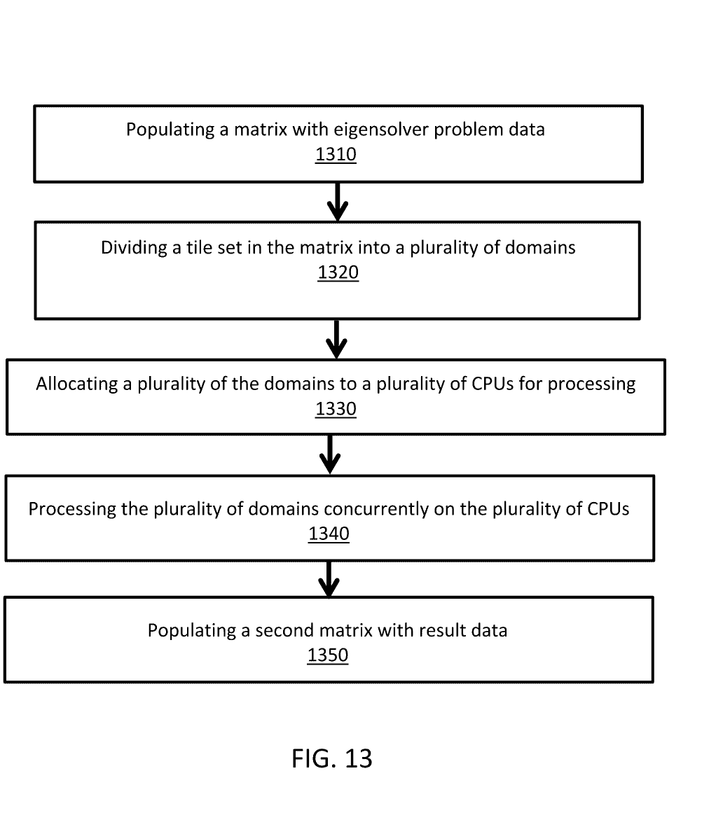

FIG. 13 illustrates an exemplary method that performs Householder computations on a plurality of Householder domains in a tile set in parallel. The method of FIG. 13 includes step 1310 that populates a matrix with Eigensolver problem data. The matrix populated in step 1310 may be a dense matrix that includes mostly non-zero data where a series of tiles each include group of rows and columns in the dense matrix, and where the dense matrix includes a series of tile sets in a series of columns of tiles of the dense matrix. As such, each tile set may be included in a series of parallel columns as shown in FIG. 12.

Next in step 1320 of FIG. 13 a tile set in the dense matrix may be divided into a plurality Householder domains and then in step 1330 a plurality of the Householder domains may be allocated to individual processing cores or CPUs. After the plurality of Householder domains have been allocated, each of the plurality of domains maybe processed in parallel at the individual processing cores in step 1340 of FIG. 13. As the process of transforming densely packed data in the dense matrix proceeds, resultant data from step 1340 may be populated in a band matrix in step 1350 of FIG. 13.

An example of performing Householder computations in parallel is where tile set 1 of FIG. 12 is broken into three different Householder domains. Here house holder domain 1 may include TS1-1 and TS1-2; Householder domain 2 may include TS1-3 and TS1-4; and Householder domain 3 may include TS1-5 and TS1-6. Similarly, the other tile sets of FIG. 12 may be broken into Householder domains and processed. Here also, a subsequent tile set may be processed in parallel with an immediately preceding tile set after a portion of the immediately preceding tile set has been processed.

Experimental results show that by dividing a dense matrix into a series of domains and transforming the dense matrix into a band matrix according to the method of FIG. 13 reduces the processing time of transforming a dense matrix into a band matrix by as much as 33% or significantly more than 33% when performed on the same hardware. As such, this presently disclosed method is superior to other methods for transforming a dense matrix into a band matrix when preparing to compute Eigenvalues and Eigenvectors. Before Eigenvalues and Eigenvectors can be calculated, however, the band matrix must be transformed into a tridiagonal matrix.

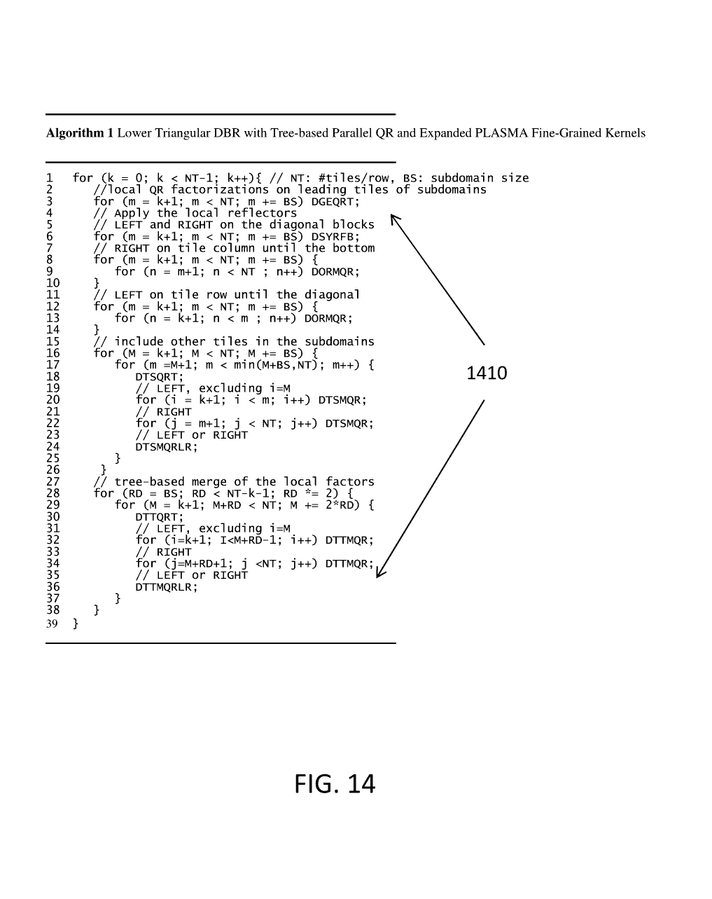

FIG. 14 depicts an algorithm implemented in program code that transforms a dense matrix into a band matrix according to the method of FIG. 13. FIG. 13 includes program code 1410 that executes faster as compared to program code 410 of FIG. 5.

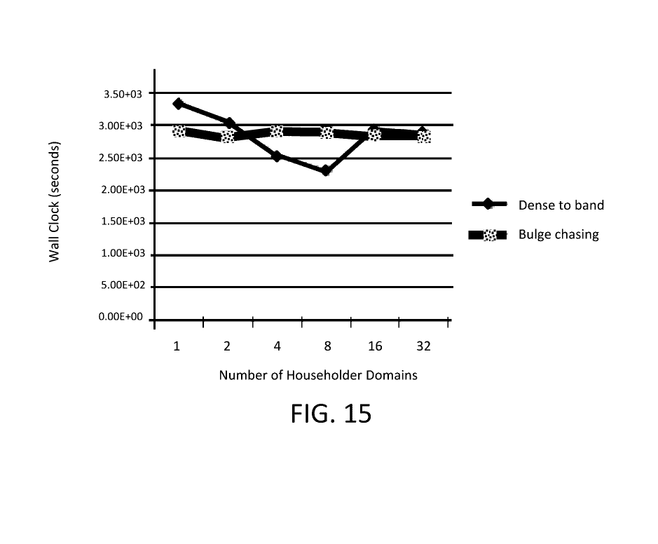

FIG. 15 illustrates the impact of dividing a tile set into a plurality of Householder domains. FIG. 15 includes a vertical axis (wall clock) of time and a horizontal axis of a number of Householder domains. The chart of FIG. 15 includes two curves a first curve including diamond shaped data points and a second curve including box shaped data points. The diamond shaped data points in FIG. 15 are measures of time to perform a dense to band reduction as the number of domains are changed. The box shaped data points in FIG. 15 are measures of time to perform a bulge chasing algorithm as the number of domains are changed. Note that the number of Householder domains significantly affects the amount of time required to perform a dense to band transformation. Note also that the number of Householder domains does not significantly affect the performance of a bulge chasing algorithm associated with transformations of the present disclosure.

The data illustrated in FIG. 15 relates to solving a 200k×200k Eigensolution problem with a tile size of 1008, using 64 SGI Ultra-Violet (UV) 2000 CPUs with different numbers of Householder domains and thread configurations of 128 by 1 for bulge chasing and 64 by 7 nested for a dense to band reduction (DBR) transformation. The results suggest that a modest number of 4 or 8 Householder domains produce the best performance, as shown in FIG. 15. Note that the time required to perform the dense to band transformation with one Householder domain was 3.4*10³ seconds and that the time required to perform the same dense to band transformation with 8 Householder domains was 2.3*10³ seconds, nearly a 33% reduction in time. As such, the number of Householder domains can drastically affect performance of the dense to band transformation.

One reason that an increased number of household domains improves the performance of the dense to band transformation in systems of the present disclosure is that processors accessing global memory may experience less contention when accessing memory. When one household domain is used, memory accessed by the processors performing the transformation is localized to a smaller portion of the overall global memory as compared to instances when multiple Householder domains are used. As such, the processors performing the transformation must compete to access data in frequently accessed regions (i.e. hot spots) of the memory when too few or one Householder domain is used. When a number of Householder domains are used, the global memory accessed by the processors may use different hardware to access different portions of the memory. This reduces the number of hot spots in memory, because a hardware resource has a reduced likelihood of reaching saturation as compared to instances when a number of hot spots are used.

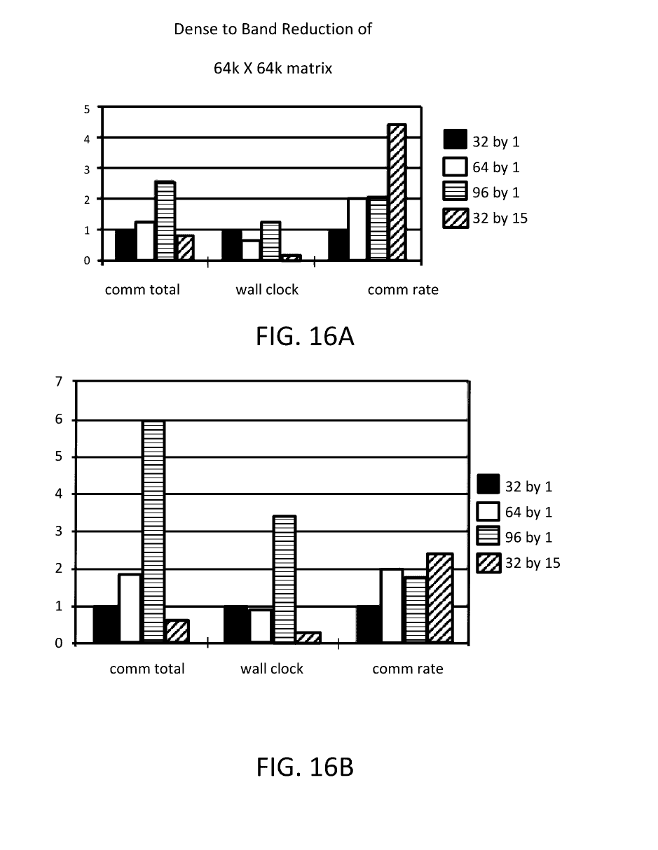

FIG. 16A and FIG. 16B illustrates dense to band reduction performance data when the dense to band reduction is performed with various resources with different numbers of Householder domains. FIG. 16A illustrates experimental data when four Householder domains were used in a dense to band reduction. FIG. 16B illustrates the same dense to band reduction performed using only one Householder domain.

Note that both FIGS. 16A and 16B include data from configurations 32×1 (32 by 1), 64×1, 96×1, and 32×15. These configurations correspond to a number of threads executed when performing the same dense to band reduction in different tests. To calculate the number of threads used for each configuration a first number X (referred to as X P-threads) must be multiplied by a second number Y threads where X also corresponds to a number of processor/multi-processor sockets. In such an instance, the number of processing cores in a processor executing the dense to band reduction may be equal to Y or greater. For example, in the 32×15 configuration (X=32 and Y=15) the process uses 32×15=480 threads executing on 32 processor sockets where each processor socket includes at least 15 processor cores.

The vertical axis in FIGS. 16A and 16B corresponds to performance metric magnitudes when the dense to band reductions are being performed. The metric of communication (comm) total corresponds to a total number of data in bytes transferred amongst the processor sockets, the metric wall clock corresponds to an amount of time required to perform the dense to band reduction, and the communication rate corresponds to a transfer rate (i.e. Gigabytes/second) of data amongst the processor sockets.

FIGS. 16A and 16B each include four sets of bars where a first bar in each set corresponds to the 32×1 configuration, the second bar corresponds to the 64×1 configuration, the third bar corresponds to a 96×1 configuration, and the fourth bar corresponds to the 32×15 configuration. Note that in the 32×1 configuration measures of communication total, wall clock (time), and communication rate are nearly identical in FIG. 16A as compared to FIG. 16B. As such, the performance of the 32×1 configuration is not sensitive a change from four to one Householder domains.

Note that in the 64×1, configuration requires a greater number of communications and more time when performing the dense to band reduction. Since the communication rate of 64×1 configuration in FIGS. 16A and 16B are the same, the communication rate of the 64×1 configuration is not sensitive to the change from four to one Householder domains. As such, the 64×1 configuration performs better when 4 Householder domains (as in FIG. 16A) are used as compared to when only 1 Householder domain is used (as in FIG. 16B).

The 96×1 and 32×15 configurations also perform better when 4 Householder domains are used. In these configurations when 4 Householder domains are used (FIG. 16B), fewer communications are required, less time is required, and the communication rate is greater than when 1 Householder domain is used (FIG. 16B). As such, performing a dense to band reduction is generally more efficient when 4 Householder domains are used as compared to when one is used. Furthermore, the bar charts of FIG. 16A do not vary as much as the bar charts of FIG. 16B the configuration is changed. This means that the dense to band reduction performance has less variability, i.e.: is more consistent (less jumpy/snappy) as the system/thread configuration is changed and when 4 Householder domains are used as compared to when only one Householder domain is used. As such, tuning the number of Householder domains optimizes performance and reduces variability as system configurations are changed.

The experimental data of FIGS. 15, 16A, and 16B, thus demonstrates that the performance of a dense to band reduction may be optimized by using a number of Householder domains rather than using a few Householder domains or one house holder domain.

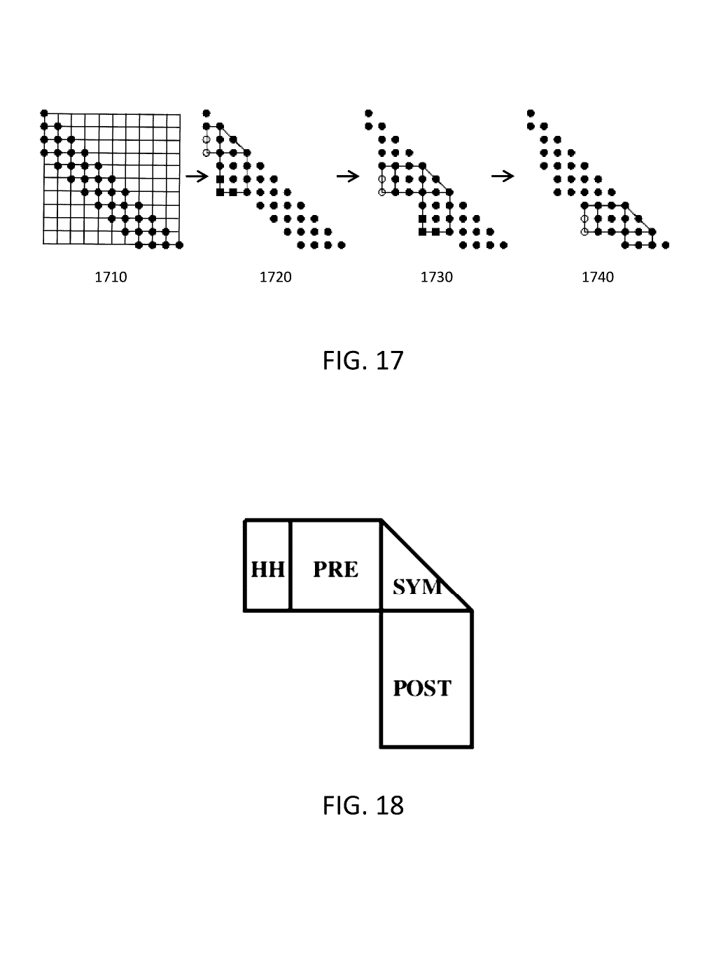

FIG. 17 illustrates a lower portion of a band matrix as it is being reduced to a tridiagonal matrix. Item 1710 in FIG. 17 depicts data stored in a band matrix. The intersections of the horizontal and vertical lines in item 1710 illustrate locations in the band matrix, where the dots indicate locations in the band matrix where non-zero data is stored. Intersections that do not include a dot are locations in the band matrix contain zeros. The diagonal shaped bands depicted in item 1710 is where the band matrix gets its name. Items 1720, 1730, and 1740 depict changes in the band matrix as it is being reduced to (converted into) a tridiagonal matrix. The small circles in items 1720, 1730, and 1740 are areas in the matrix that have recently been zeroed during the band reduction. The lines interconnecting the dots, the circles, and the square areas in items 1720, 1730, and 1740 in FIG. 17 represent areas in the matrix that have recently been changed as the band reduction progresses from steps 1710 to 1720, then to 1730, and 1740. The square areas in items 1720, 1730, and 1740 represent locations in the band matrix recently populated with non-zero data as the band matrix is reduced. These square areas are also locations in the matrix that previously contained zeros. Note that these square areas protrude away from areas that previously contained non-zero data, as such, these squares are a “bulge” in the band matrix that will be smoothed out as the band to tridiagonal reduction proceeds. The process of smoothing out of the bulge is commonly referred to as “bulge chasing.” As the “bulge chasing” process proceeds matrix will have been converted into a tridiagonal matrix. For this particular symmetric band matrix the resulting tridiagonal matrix will be converted in to a tridiagonal matrix that includes two diagonal lines of non-zero data.

While the process of “bulge chasing” is not new, this disclosure discloses optimizations for improving the performance of smoothing the bulge when reducing the band matrix to the tridiagonal matrix. FIG. 18 illustrates regions in the matrix as the “bulge chasing” process proceeds. FIG. 18 includes a first zone of HH, a second zone of PRE, a third zone of SYM, and a fourth zone of POST, where each of these zones correspond to data stored in the matrix according to an HH step, a PRE step, and SYM step, and a POST step of the bulge smoothing process. Data in the HH zone needs to be zeroed by multiplying it by a Householder reflector. The HH zone may include a single column from which a scaling vector and a Householder reflector can be generated. The PRE zone represents locations in the matrix where previous data is stored. This previous data is data that existed in the matrix before the band to tridiagonal reduction process began or that existed in the matrix before a current pass of an iterative reduction process. As such, the PRE data may be data contained in the initial band matrix or may be data that was populated in a previous pass of the iterative reduction process. The POST zone represents locations where POST data is stored from a POST step of the reduction process, where at least a portion of the POST data may be the bulge illustrated in FIG. 17. They SYM step relates to the symmetric application of a Householder reflector to a diagonal matrix (such as b×b).

The processes of performing a band to tridiagonal reduction and bulge chasing include a series of iterative matrix-vector calculations where a Householder reflector is generated according to the formula HHR=I−τ·ν·ν^{t} (i.e. equation 1) here I is an identity matrix, τ (tau) is a first Householder scaling factor, ν is a Householder column vector, ν^{t} is a Householder row vector, and HHR is the Householder reflector. Equation 1 generates Householder reflector by subtracting the product of a current Householder scaling factor (T) with a Householder column vector (ν) and with a Householder row vector (ν^{t}) that when applied to a corresponding HH zone column, zeros out values in the corresponding HH zone. Typically ν is a N×1 column vector and ν^{t} is a 1×N row vector. An identity matrix is a matrix where the diagonal elements contain a value of one and all other columns and rows contain a value of zero. As such, column/row combinations 1/1, 2/2, 3/3, 4/4, . . . contain ones.

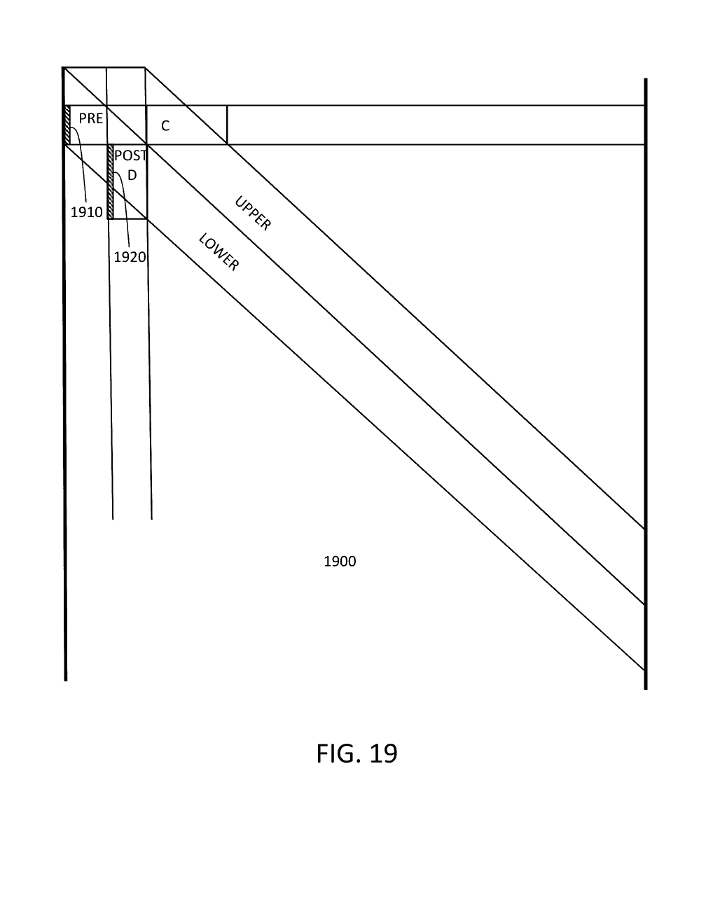

FIG. 19 illustrates a band matrix, where banded data in the band matrix includes an upper and a lower part. The upper part of the part of the banded data is labelled “UPPER” and the lower part of the banded data is labelled “LOWER.” Initially the value in HH zone 1910 of FIG. 19 must be zeroed when reducing the band matrix to a tridiagonal matrix. To accomplish this, a Householder reflector is generated from the HH column first, then applied to HH from the left to zero it out. The Householder reflector also is applied to areas PRE and C of the matrix from the left. Since this is a symmetric matrix, the data in the C area is equivalent to the transposition of the data in the D area. As such, the area associated with the D area is POST zone identified in FIG. 19. Note that the Householder reflector is applied to area D from the right due to the transposition. Since the area 1920 is an HH zone, it must also be zeroed out during the bulge chasing process. The process includes repeatedly multiplying the recently generated POST data (area D data) with a new Householder reflector generated from the new HH zone 1920 as the bulge chasing process proceeds.

The bulge smoothing process may be implemented using three different kernels. One of these kernels, let's call it DSBRCE, performs the function of multiplying data in area D by a previous Household reflector (HHRprev), generating a new Householder reflector, and applying the new Householder reflector to the D region minus the first column. As such three different steps of A. Applying the Household reflector from the previous kernel from the right (from a POST area); B. Generating a new Household reflector that eliminates the leading column of the bulge (from the HH area such as 1920); and C. Applying the new Household reflector from the left (from a PRE area). In certain instances steps A. and C. may be performed by a first LAPACK kernel (DLARFX) and step B may be performed by a second LAPACK kernel (DLARFG).

Since this process utilizes the formula of equation 1. Note that D·HHRprev=D·(I−τ·ν·ν^{t})=D·I−D·τ·ν·ν^{t}=D−τD·ν·ν^{t}. Note to perform this calculation by DLARFX, data from the D area is typically accessed two times, one time when evaluating the product D·τ·ν·ν·ν^{t} and a second time when evaluating D−D·τ·ν·ν^{t}. For Steps A and C, DSBRCE operations would have to access D for a total of four times if the LAPACK approach is used. In the second step where the new Householder reflector is generated, a second Householder scaling factor \acute{α} (alpha) must be generated. According to equation 1, HHRprev=I−τ·ν·ν^{t} and HHRnew=I−\acute{α}·u·u^{t}. Note that ν and u are Householder column vectors, and that ν^{t} and u^{t} are Householder row vectors. The mathematical operations of reducing the band matrix into a tridiagonal matrix in one iteration uses a formula of an original LAPACK formula that corresponds to the calculation of: HHnew·D·HHprev=(I−\acute{α}·νu·u^{t})·D·(I−τ·ν·ν^{t})=(D−\acute{α}·u·u^{t}·D)·(I−τν·ν^{t})=D−\acute{α}·u·u^{t}·D−D·τ·ν·ν^{t}+\acute{α}·u·u^{t}·D·ν·ν^{t}. When w=D·ν, beta=u^{t}*w, sigma=\acute{α}*τ*beta, and WORK=−τw+sigma*u, this equation simplifies to D−\acute{α}·u·u^{t}·D+WORK·ν^{t}. Note, here data D apparently is accessed from memory three times, once in computing w=D·ν and twice in evaluating the D−\acute{α}·u·u^{t}·D+WORK·ν^{t} formula, when these various bulge chasing algorithms are executed. When data D is located in global memory, the multiple times that data D is retrieved delays associated with accessing global memory will be incurred. As such, if global memory were accessed less frequently, time could be saved.

One characteristic of matrix mathematics is that a matrix times vector yields a vector. Furthermore, a vector requires less memory than a matrix to store. Matrix-vector multiplications can be performed on a column by column basis when calculating a result. As such, the formula D−\acute{α}·u·u^{t}·D+WORK·ν^{t} may be evaluated column by column in a column-wise formula instead of being evaluated in a form consistent with the original LAPACK formula. For example a first column evaluated in this way is expressed by: d₁−\acute{α}·u·u^{t}·d₁+WORK·σ₁ where d₁ is the first column vector in matrix D. As this expression is evaluated in this way iteratively, each column of D is likely to stay in the processor cache due to the small amount of data involved, and D is accessed only once from global memory. This is because a processing core may execute calculations on a mathematical expression that is equivalent to, yet transformed from an original form. In essence this improvement relates to reading a matrix from global memory, performing a number of calculations using elements from the matrix, and storing results from those calculations locally, wherein the elements from the matrix correspond to data in a column of the matrix. Instead of performing matrix calculations as one might obviously perform manually, a processing core using equivalent operations using such columnized matrix data will perform these operations more efficiently than the same processor performing calculations without separating the matrix into columns. If the calculations were performed according to the original LAPACK formula, matrix D would have to be read 4 times. In contrast, when the calculations are performed according to the equivalent column-wise formula, matrix D would be read 3 times. As such, this process results in fewer accesses to global memory and increased performance. In certain instances the resultant data may be stored in a local memory, preferably a fast memory such as a level 3 (L3) or other cache for subsequent accesses time could be saved and the performance of the bulge chasing process could be increased. As such, a rule where data associated with matrix data contained in global memory is accessed could be established. Such a rule may cause matrix calculations to be performed column by column according to a formula Since the resulting data includes many vector multiplications and since vector calculations result in vectors, the memory required to hold the resultant data may be minimized. As such, the resultant data may be stored in a highly available memory, such as a cache, where it may be accessed very quickly. Note that cache memories at a processing core may include level 1 (L1), level 2 (L2), and level 3 (L3) caches. Note also that these cache memories are not the same local memory that resides at a socket or core. Typically such cache memories are faster and are located at a different architectural level than what is commonly referred to as local memory.

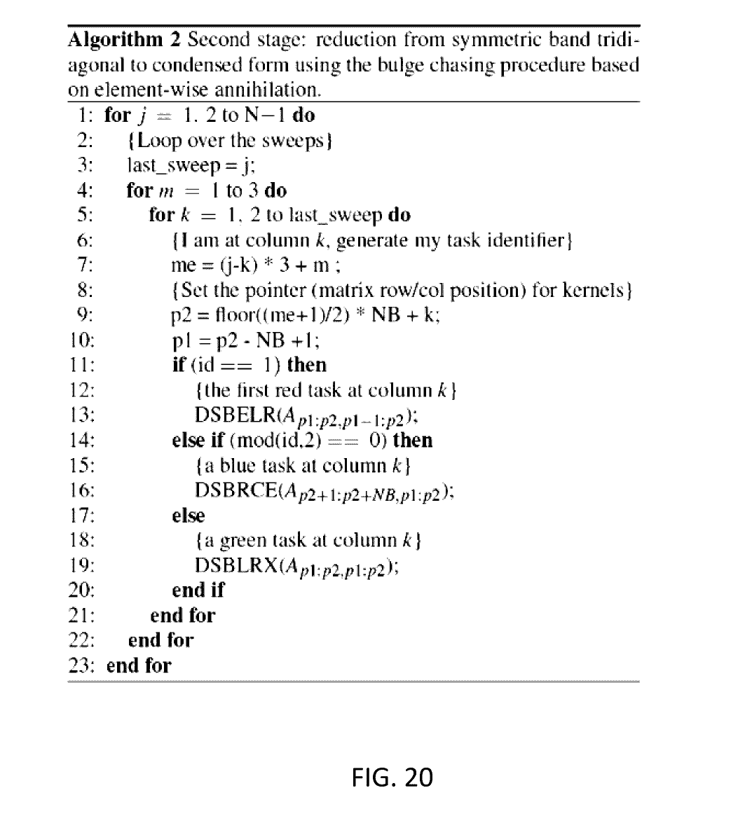

FIG. 20 illustrates program code that implements the improved bulge chasing method consistent with the present disclosure.

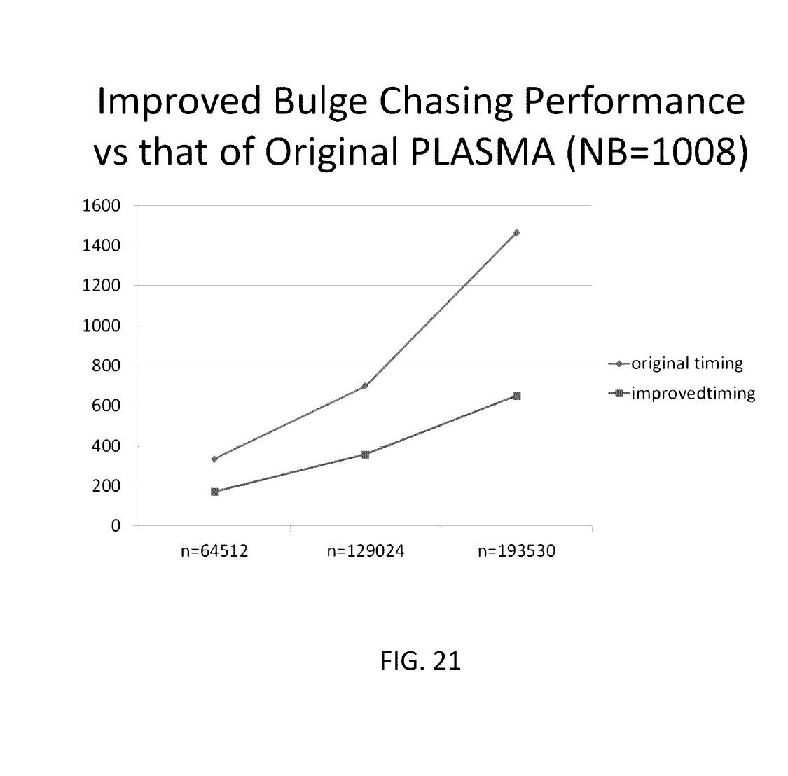

FIG. 21 illustrates data from that compares the performance of a bulge chasing method as implemented originally in PLASMA versus the performance when bulge chasing is performed with the program code of FIG. 20. The vertical axis of FIG. 21 corresponds to execution wall clock in seconds, and the horizontal axis corresponds to problem size. Note that program code consistent with the present disclosure is utilized, the performance of the bulge chasing method improves significantly.

In certain instances, several different kernels could be used when performing bulge chasing. For example, a first kernel (DSBELR) could trigger the beginning of a bulge chase sweep and apply symmetric updates to the diagonal areas of the matrix; a second kernel (DSBRCE) could successively apply all of the right updates from the previous kernel DSBELR, or DSBLRX (described below), and eliminate the subsequent single bulges, and apply the left updates; and a third kernel (DSBLRX) could apply all of the symmetric updates coming from the DSBRCE kernel. Potentially, these different kernels could access the same matrix data that was retrieved via a global memory access and stored in the highly available memory, further increasing the performance of the bulge chasing process.

When a computational task is executed on a processor, the use of local memory to hold the data is always preferred. This is because accessing local memory incurs less latency than accessing global memory. However, such processing affinity may not always be feasible if a piece of data is needed by more than one processor. Therefore, in designing a parallel algorithm, the programmer always would try to distribute the underlying data over the participating processing sockets and assign the computational tasks to the local processors that hold the respective data if possible. If such affinity is not possible, then data will have to be read or written by non-local processor. In this case, using interleaved policy to distribute memory pages in round-robin across all the processing sockets to avoid communication hotspot would be a good practice.

Since the Eigenvector back-transformation algorithms for tridiagonal to band and band to dense allow processing affinity between the processors and the Eigenvector matrix, the Eigenvector matrix is divided up into pieces according to the number of processing sockets and the pieces are stored in the memory on the sockets that will process them accordingly. The other matrices that are required for the Eigenvector back-transformations still are stored with interleaved memory pages across all the participating sockets.

Memory policies of the present disclosure may be switched dynamically based on the processing affinity feasibilities and communication hotspot avoidance. Tailoring memory policy may, thus help optimize the performance of a given task.

Typically local memory is smaller than global memory and local memory accesses commonly have less latency and greater throughput (memory access rates) than accesses to global memory. However, with the scalable shared memory architecture such as that of SGI UV, it is possible to establish full or partial memory and processor affinity even in a complex computing algorithm. Because of these factors local methods that use local memory and processor may provide increased performance as compared to a same task executing out of global memory.

Methods consistent with the present disclosure may, therefore, identify the feasible memory and processor affinities to complete a given task and set a memory policy accordingly before performing the given task. Because of this, global memory policies may be used to when performing reduction tasks or when performing back-transformations and local memory policies may be used when calculating Eigenvalues and Eigenvectors.

Factors relating to the overall performance of bulge chasing algorithms include an amount of communication and a number of computations that must be performed when reducing a bulge. The performance of a bulge chasing algorithm be inversely proportional to a communication to computation ratio. As such, the more the amount (i.e. a number) of communications per computation is reduced the more performance of the bulge chasing process should increase. Since larger tile sizes may reduce the amount of communications, it may be beneficial to select a larger tile size when performing dense to band reductions. When larger tile sizes are selected, the bulge chasing algorithm will also tend to require fewer numbers of threads required to perform the bulge chasing algorithm. For a matrix that includes only a single tile it is possible to perform the bulge chasing algorithm using only one thread. When S refers to a number of processor sockets and when m refers to an integer that corresponds to some integer that is less than the number of cores (processing cores) in each processor socket the number of threads required to perform the bulge chasing algorithm correspond to the formula: Number of Threads=S*m (number of processor sockets times the integer m).

One way by which the performance of the bulge chasing process may be increased is by using a thread to CPU mapping that distributes threads across a plurality of CPU sockets that results in more efficient bulge chasing computations. A relatively poor thread to CPU mapping is exemplified by a linear mapping of threads to CPU sockets where: socket #0 is assigned threads 0-1; socket #1 is assigned threads 2-3; socket #2 is assigned threads 4-5, and socket #3 is assigned threads 6-7. Such a linear mapping maps a number of sequential threads to each respective socket.

A preferred mapping of threads to processor sockets is a round-robin fashion where the threads are distributed as shown in Table 1 below. In this round-robin scheme, threads are distributed according to a progression correspond to or a number of processor sockets S times an offset. In the instance where 4 processor sockets are used, threads will be mapped according to the progression: assign thread 0 to socket #0, assign thread 1 to socket #1, assign thread 2 to socket #2, assign thread 3 to socket #3, assign thread 4 to socket #0, assign thread 5 to socket #1, assign thread 6 to socket #2, assign thread 7 to socket #3

TABLE 1

| Socket #0 | Socket #1 | Socket #2 | Socket #3 |
|---|---|---|---|
| Thread 0 | Thread 1 | Thread 2 | Thread 3 |
| Thread 4 | Thread 5 | Thread 6 | Thread 7 |

FIG. 22 illustrates how the allocation of threads to CPU or socket core mapping affects workload distribution on a plurality of processor sockets when reducing a band matrix into a tridiagonal matrix. FIG. 22 identifies workload distribution using a tensor like notation of the form:

^{x}T^{y}_{z}

This tensor like notation identifies a thread number x, a sweep number y, ie. variable j in FIG. 20, and task number of a sweep z, ie. variable me in FIG. 20. As such, when x=3, y=2, and z=4; task number 4 of sweep number 2 is being excuted on thread 3. When P is a number of parallel threads, x may range from 0 to P−1 according to a rule. Given a matrix of order N, the sweep number may range from 1 to N. Note that a task can be either a task performed by the DSBELR, DSBRCE, or by the DSBELX kernel. Not all tasks can be executed at the same time with parallel threads. The task can be executed on any thread only after tasks [symbol] T^{y}_{z-1} and [symbol] T^{y-1}_{z-2} are completed on any thread. For performance, two consecutive tasks of the same sweep also are grouped together to be executed by the same thread.

FIG. 20 illustrates a plurality of different tasks being executed on band matrix 2000 using tensor like notation. Notice that each of these tasks has a different combination of thread number, sweep number, and task number. The tasks included in box 2010 of FIG. 20 correspond to a number of tasks assigned to and executing on socket #0 at a same time, and the tasks included in box 2012 correspond to a number of tasks assigned to and executing on socket #1 at a same time, when the threads were assigned using a round-robin thread mapping technique. The tasks include in box 2020 of FIG. 20 correspond to a number of tasks assigned to and executing on socket #0 at a same time when the threads were assigned using a linear mapping technique. Notice that the round-robin allocation mapping technique reduces the number of columns to be processed on socket #0 by half. This means that the linear mapping technique causes a greater workload to execute on socket #0 as compared to the round-robin mapping technique when solving the same problem. This means that the workload on socket #0 may be greater than the workload on other sockets in the system. As such, the linear mapping technique does not balance loads on the system as well as the round-robin mapping technique. Since computer systems operate more efficiently when workloads are balanced between a plurality of computing resources, the round-robin mapping technique will yield to greater compute throughput and faster execution.

As mentioned above, after the dense to band and the band to tridiagonal reductions are performed, Eigenvectors and Eigenvalues are computed. In certain instances, changing the memory policy from using global memory accesses to using local memory accesses for different Eigensolver tasks can significantly affect the performance and efficiency of a particular task. As Eigensolver solutions require two different transformation steps, a step where Eigenvalues and Eigenvectors are calculated, and two different back-transformation steps, any one of these steps may benefit from using a different memory policy than another. Typically, however, the first two reduction steps have better performance when a global interleaved memory policy is used. Since the calculations of Eigenvalues and Eigenvectors does not consume a large percentage of the overall compute time of an Eigensolver, the step where these values are calculated may also be performed using a global memory policy. Since the last two steps, the back-transformation steps, operate on the calculated Eigenvectors and since there may be a large number of Eigenvectors, these back-transformation steps perform better when the eigenvectors are stored on local memory. As such, switching the memory policy to a local memory policy may optimize the performance of the back-transformation steps.

For example, the memory policy may be configured to use global memory accesses when performing the reduction steps and may be switched to using local memory to allocate and initialize the Eigenvector matrix. As such, the dense to band and the band to tridiagonal reductions may be executed using a global memory policy, and the tridiagonal to band and the band to dense back transformations may be executing using a local memory policy for the eigenvectors. As such the memory policy may be switched to using local memory before allocating and initializing memory used to store calculated Eigenvectors before any back-transformation is performed.

Other techniques that may be used to optimize memory accesses may relate to changing how memory is accessed before performing a given task. The effects of hot spots in memory when performing reductions or back-transformations may be mitigated by accessing global memory in an interleaved fashion. By interleaving memory accesses a first processor may access a first memory element (or a first portion of memory) at one moment in time while a second processor accesses a second different memory element (or a second portion of memory). Subsequently, the second processor may access the memory the first portion of memory and the first processor may access the second portion of memory. After each processor has accessed data from the different memory elements, processing tasks associated with data stored in the different memory elements may be processed without the two different processors competing for a same memory element at the same time. As such, interleaving memory may reduce bus and network contention that can reduce the performance of the Eigensolver.

When local memory is being used to complete a task, the local memory may be accessed by one or more processors in one or more processor sockets. Since the back-transformations of the Eigenvectors benefit most from a local memory policy and since other tasks are executed during that back-transformations, some tasks may be performed using a local memory policy where other tasks may be executed using a global memory policy during the back-transformations. For example, Eigenvectors may be stored according to a local memory policy and Householder scaling factors and Householder vectors may be stored according to a global memory policy. In certain instances, not interleaving memory accesses may be desired or required depending on how the local memory is organized. In an instance where a plurality of processors that share the same local memory with a common bus, each processor may be configured to access memory sequentially, without interleaving, when optimizing performance. Since, in such an instance, the two processors must use the same bus to access the local memory and since local sequential memory requests are associated with high data throughput, interleaved memory requests may reduce the performance of calculations performed by the processors. This is because interleaved memory requests are characteristically non-sequential. For example, when the first processor reads local memory, it may read a range of memory addresses quickly and completely and then allow another processor to access the local memory quickly and completely. In contrast, if such memory accessed were interleaved, each of the processors would have to access local memory more frequently over the same bus reducing performance because of increased contention for access to the memory bus. When local memory policies are used for managing the Eigenvectors each individual piece of memory may be mapped to a computational task according to a 1 to 1 correspondence.

The processing step where the matrix is reduced from dense to band corresponds to the processing step that back-transforms Eigenvectors from a band to a dense format. Because of this correspondence, the dense to band reduction step and the band to dense back-transformation must share information. Because of this step 1 and step 5 of the Eigensolver share information relating to Householder scaling factors and Householder vectors. Similarly, since the band to tridiagonal reduction step and the tridiagonal to band back-transformation must also share information. Because of this step 2 and step 4 of the Eigensolver also share information relating to Householder scaling factors and Householder vectors. As such, scaling factors and scaling vectors may be stored in memory for later reference.

When preparing to perform operations consistent with the present disclosure memory may be allocated according to one or more requirements of the problem to be solved. In certain instances, memory may be allocated in chunks by a series of different processes. For example, memory may be allocated before calculating the Eigenvectors and Eigenvalues. After the memory is allocated it may be initialized, where the initialization of the memory may include zeroing or writing zeros to the allocated memory. In one example memory for storing Eigenvectors may be allocated in blocks of 200 memory locations at a time by different processes. In such an instances memory locations 1-200 could be allocated by process 1, memory locations 201-400 could be allocated by process 2, and memory locations 401-600 could be allocated by process 3.

As previously discussed larger tile sizes correspond with more efficient processing when computing steps 410, 440 and 450 of the eigensolution. On the other hand performance of step 420 may be adversely impacted for large tile sizes. As such, the tile size should be large, yet not too large. The optimal tile size is determined by the balance of the per socket processing power and the inter-socket communication bandwidth, among various factors. The efficiency of manipulating tiles may also be affected by the number of processing sockets applied (allocated) to a problem. Furthermore, it has been observed that when the problem size is evenly divisible by the tile size, the performance of the Eigensolver is greater than when the problem size cannot be divided by the tile size. For best work load balance the number of tiles per row or per column should be divisible by the number of sockets applied (allocated) to solve the problem.

Since good tile sizes correspond to a number of processor sockets and a problem size being ones that can produce whole tiles and best work load balance, a preferred tile size for a given problem should result in a number of tiles that is divisible by the number of processor sockets associated with the problem. In an instance where the problem size is not evenly divisible by the tile size, the corresponding matrix for solving the problem may be adjusted. For example, when a problem may be minimally described by using 12345 elements in a matrix and 127 sockets will be allocated to solve the problem, a larger tile size could be used when solving the problem. Since 12345/127=97.2, then a tile size of 12345 is not evenly divisible by 127. Since 127*98=12446, then 12446 corresponds to a tile size that will result in a more efficient processing of the problem than a problem size of 12345. As such a matrix containing the 12446 elements will have to be populated. Since this problem is described with a problem size including 12345 elements, and since want to represent this problem using 12446 elements, a matrix containing the 12446 elements must be padded with 101 zeros. Typically the last tile in the matrix will contain the extra zeros. As such, even though the matrix includes more elements than are required, the problem will be solved more efficiently than if a matrix of 12345 elements were used.

Another way to reduce communications applications such as crash simulation and weather forecast, hybrid MPI+OpenMP codes would be sometimes used to improve performance. The idea behind that is there would be less communication with less numbers of domains, so adding OpenMP threads within each domain would increase the processing power, but not the volume of communication, and is therefore likely to improve performance. With nested SMP, ie. running a small group of OpenMP threads under each PLASMA thread, the dense to band reduction performance for running 15 OpenMP threads per PLASMA thread would go much higher as the total volume of communication basically stays flat as shown in FIG. 10. It is interesting to note while the communication total is basically the same for the 32 by 1 and the nested 32 by 15 cases, the rate of communication is much higher with the latter as the latter also gets much better performance.

The foregoing description is not intended to be exhaustive or to limit the technology to the precise form disclosed. Many modifications and variations are possible in light of the above teaching. The described embodiments were chosen in order to best explain the principles of the technology and its practical application to enable others skilled in the art to best utilize the technology in various embodiments and with various modifications as suited to the particular use contemplated. It is intended that the scope of the technology be defined by the claims appended hereto.

What is claimed is:

1. A method for computing eigenvectors, the method comprising:
populating data in a matrix, the matrix densely populated with non-zero values;
identifying a plurality of tile sets in the matrix according to a first matrix configuration;
identifying a first set of a plurality of domains in a first tile set of the plurality of tile sets;
allocating a plurality of central processing units (CPUs) for processing, wherein each of the plurality of central processing units are coupled to one or more memories;
concurrently processing by the plurality of CPUs data from at least two domains of a plurality of domains in the first tile set, wherein the processing converts at least a portion of data in the at least two domains of the plurality of domains in the first tile set from a dense format into a first portion of data in a band format; and
storing the at least first portion of data in the band format.

2. The method of claim 2, further comprising:
concurrently processing by the plurality of CPUs data from at least two domains of the plurality of domains in a second tile set concurrently by the plurality of CPUs, wherein the processing converts data in the at least two domains of the plurality of domains in the second tile set from a dense format into at least a second portion of data in the band format;
storing the at least second portion of data in the band format;
processing by the plurality of CPUs data from at least two domains of the plurality of domains in a third tile set concurrently by the plurality of CPUs, wherein the processing converts data in the at least two domains of the plurality of domains in the third tile set from a dense format into at least a third portion of data in the band format; and
storing the at least third portion of data in the band format.

3. The method of claim 1, further comprising:
processing data from the matrix in the band format, wherein the processing of the data from the band format converts the data in the band format to at least a portion of data in a tridiagonal format;
performing calculations on the at least portion of data in the tridiagonal format, wherein the calculations on the at least portion of data in the tridiagonal format generate a plurality of eigenvalues and a plurality of eigenvectors;
storing the plurality of eigenvalues in a memory of the one or more memories;
performing a back-transformation on the plurality of eigenvectors wherein the back transformation on the plurality of the eigenvectors converts the eigenvectors into a plurality of eigenvectors in a band format; and
performing a second back-transformation, the second back transformation converting the plurality of eigenvectors in the band format in to eigenvectors in a format consistent with the dense format.

4. The method of claim 1, further comprising allocating memory to store the matrix.

5. The method of claim 1, wherein the plurality of CPUs are located at a plurality of different nodes that communicated with each other over one or more communication interfaces.

6. The method of claim 3, wherein a memory policy is changed from a global memory policy to a local memory policy before allocating and initializing memory for storing the computed Eigenvectors.

7. The method of claim 1, further comprising:
identifying a problem size, wherein the problem size is associated with a number of elements required to describe an Eigenproblem;
identifying a number of processor sockets to allocate to solving the Eigenproblem;
identifying a tile size, wherein the tile size results in a number of tiles in a tile set that is divisible by the number of processor sockets; and
identifying a padded problem size that is equal to or larger than the problem size and is evenly divisible by the tile size, wherein the matrix is populated with the number of elements required to describe the Eigenproblem and with a number of zero entries corresponding to the number of elements in the padded problem size minus the number of elements in the problem size.

8. The method of claim 3, further comprising:
reading a second matrix from global memory;
dividing the second matrix into a plurality of columns; and
performing vector calculations on data contained in the plurality of columns, wherein the vector calculations are according to a column-wise formula that is equivalent to an original formula, and the calculations according to the column-wise formula are performed without reading the second matrix a third time from the global memory.

9. The method of claim 3, wherein a plurality of threads are allocated to execute on the plurality of CPUs according to a non-sequential distribution to each of the plurality of CPUs, and each of the plurality of CPUs correspond to a different processing socket of a plurality of processing sockets.

10. A non-transitory computer readable storage medium having embodied thereon a program executable by one or more processing cores to perform a method for computing eigenvectors, the method comprising:
populating data in a matrix, the matrix densely populated with non-zero values;
identifying a plurality of tile sets in the matrix according to a first matrix configuration;
identifying a first set of a plurality of domains in a first tile set of the plurality of tile sets;
allocating a plurality of central processing units (CPUs) for processing, wherein each of the plurality of central processing units are coupled to one or more memories;
concurrently processing by the plurality of CPUs data from at least two domains of a plurality of domains in the first tile set, wherein the processing converts at least a portion of data in the at least two domains of the plurality of domains in the first tile set from a dense format into a first portion of data in a band format; and
storing the at least first portion of data in the band format.

11. The non-transitory computer readable storage medium of claim 10, the program further executable to:
process by the plurality of CPUs data from at least two domains of the plurality of domains in a second tile set concurrently by the plurality of CPUs, wherein the processing converts data in the at least two domains of the plurality of domains in the second tile set from a dense format into at least a second portion of data in the band format;
store the at least second portion of data in the band format;
process by the plurality of CPUs data from at least two domains of the plurality of domains in a third tile set concurrently by the plurality of CPUs, wherein the processing converts data in the at least two domains of the plurality of domains in the third tile set from a dense format into at least a third portion of data in the band format; and
store the at least third portion of data in the band format.

12. The non-transitory computer readable storage medium of claim 10, the program further executable to:
process data from the matrix in the band format, wherein the processing of the data from the band format converts the data in the band format to at least a portion of data in a tridiagonal format;
perform calculations on the at least portion of data in the tridiagonal format, wherein the calculations on the at least portion of data in the tridiagonal format generate a plurality of eigenvalues and a plurality of eigenvectors;
store the plurality of eigenvalues in a memory of the one or more memories;
perform a back-transformation on the plurality of eigenvectors wherein the back transformation on the plurality of the eigenvectors converts the eigenvectors into a plurality of eigenvectors in a band format; and
perform a second back-transformation, the second back transformation converting the plurality of eigenvectors in the band format in to eigenvectors in a format consistent with the dense format.

13. The non-transitory computer readable storage medium of claim 10, further comprising allocating memory to store the matrix.

14. The non-transitory computer readable storage medium of claim 10, wherein the plurality of CPUs are located at a plurality of different nodes that communicated with each other over one or more communication interfaces.

15. The non-transitory computer readable storage medium of claim 12, wherein a memory policy is changed from a global memory policy to a local memory policy before allocating and initializing memory for storing the computed Eigenvectors.

16. The non-transitory computer readable storage medium of claim 10, the program further executable to:
identify a problem size, wherein the problem size is associated with a number of elements required to describe an Eigenproblem;
identify a number of processor sockets to allocate to solving the Eigenproblem;
identifying a tile size, wherein the tile size results in a number of tiles in a tile set that is divisible by the number of processor sockets; and
identifying a padded problem size that is equal to or larger than the problem size and is evenly divisible by the tile size, wherein the matrix is populated with the number of elements required to describe the Eigenproblem and with a number of zero entries corresponding to the number of elements in the padded problem size minus the number of elements in the problem size.

17. The non-transitory computer readable storage medium of claim 12, the program further executable to:
read a second matrix from global memory;
divide the second matrix into a plurality of columns; and
perform vector calculations on data contained in the plurality of columns, wherein the vector calculations are according to a column-wise formula that is equivalent to an original formula, and the calculations according to the column-wise formula are performed without reading the second matrix a third time from the global memory.

18. The non-transitory computer readable storage medium of claim 12, wherein a plurality of threads are allocated to execute on the plurality of CPUs according to a non-sequential distribution to each of the plurality of CPUs, and each of the plurality of CPUs correspond to a different processing socket of a plurality of processing sockets.

19. A system for computing eigenvectors, the system comprising:
a plurality of nodes, wherein each of the plurality of nodes includes:
one or more processor sockets,
memory local to the one or more processor sockets, and
one or more network interfaces that couples the local memory to each other node of the plurality of nodes, wherein a processing core at the one or more processor sockets:
populates data in a matrix, the matrix densely populated with non-zero values,
identifies a plurality of tile sets in the matrix according to a first matrix configuration,
identifies a first set of a plurality of domains in a first tile set of the plurality of tile sets,
allocates at least one CPU of the plurality of central processing units,
concurrently processes data from at least two domains of a plurality of domains in the first tile set data from at least two domains of a plurality of domains in the first tile set, wherein the processing converts at least a portion of data in the at least two domains of the plurality of domains in the first tile set from a dense format into a first portion of data in a band format, and stores the at least first portion of data in the band format.

20. The system of claim 19, wherein the one or more processing sockets:
concurrently processes data from at least two domains of the plurality of domains in a second tile set, wherein the processing converts data in the at least two domains of the plurality of domains in the second tile set from a dense format into at least a second portion of data in the band format;
store the at least second portion of data in the band format;
concurrently process data from at least two domains of the plurality of domains in a third tile set, wherein the processing converts data in the at least two domains of the plurality of domains in the third tile set from a dense format into at least a third portion of data in the band format; and
store the at least third portion of data in the band format.
